(19) United States
(12) Patent Application Publication
(10) Pub. No.: US 2012/0221998 A1
(43) Pub. Date: Aug. 30, 2012

(54) SCREENFLOW DESIGNER WITH AUTOMATICALLY CHANGING VIEW

(75) Inventors: Michael T. Rowley, Lexington, MA (US); Christopher C. Keller, Monroe, CT (US)

(73) Assignee: ACTIVE ENDPOINTS, INC., Waltham, MA (US)

(21) Appl. No.: 13/403,710

(22) Filed: Feb. 23, 2012

Related U.S. Application Data
(60) Provisional application No. 61/446,298, filed on Feb. 24, 2011.

(51) Int. Cl. G06F 9/44

(52) U.S. Cl. 717/105

(57) ABSTRACT

The invention relates to an application development tool that employs a tree design environment as the graphical user interface on a computing system's display. The development tool allows a developer to create an application graphically and within a window of the display by defining a plurality of nodes that together form a tree. Each of the nodes represents a screen to be displayed to a user when the application is executed or an activity to be performed when the application is executed. In response to selecting a node, the development tool automatically moves one or more nodes, collapses one or more branches of the tree, and expands one or more branches of the tree within the window to show the selected node and also one or more nodes before and after the selected node within the available space of the window and without changing the size of the window.

### CROSS-REFERENCE TO RELATED APPLICATION

This claims priority to and the benefit of Provisional U.S. Patent Application Ser. No. 61/446,298, filed on Feb. 24, 2011, the entirety of which is incorporated herein by reference.

### TECHNICAL FIELD

The invention generally relates to an application or screenflow development and simulation tool that utilizes a tree structure to represent the flow of an in-development or a developed application or screenflow and also employs dynamic changing of the tree structure to best fit the available space in the display window.

### BACKGROUND INFORMATION

Companies often desire to transfer the know-how of a domain expert, such as a highly experienced employee, to any other employees in a manner that allows the other employees to easily know what to do and when. In order to transfer know-how, companies utilize workflow or screenflow software applications to direct the work path and problem solving of the employees. The ultimate goal of such applications is to allow one with limited knowledge of a problem or subject matter to solve a problem or complete a task with the same efficiency as the domain expert by using the application and thus following the pre-defined workflow.

The most efficient way to transfer the domain expert's knowledge is to have the domain expert design and develop the workflow application. However, the task of designing and developing workflow applications is complex and typically requires computer programmers. Because domain experts are not always computer savvy, let alone computer programmers, there is often a need for a third party programmer to work with the domain expert to create a workflow application. The need for a third party programmer can be costly and prevents the domain expert from easily updating the workflow application. In response to this problem, software application and workflow development tools have been designed to allow a non-computer programmer to create workflow applications without the extensive use of a computer programmer.

Software application workflow development tools are generally known. See, for example, U.S. Pat. Nos. 7,100,147, 7,810,078, 7,272,820, 7,774,720, 6,335,998, 6,243,092, and 7,200,838. Known software and application development tools often utilize graphs models, in which the domain expert, turned workflow application developer, creates graphs of the workflow that can be transformed into the application. Each object in the graph represents a step a user takes within the workflow application. Workflow development tools that utilize the graph format show the workflow at the individual step level or the entire graph level within the graphical user interface window of a computer. Neither the individual step level nor the entire graph level allows the developer to focus on a specific path within the workflow. In addition, many graph model development tools still require a programmer to transform the graph into an executed workflow application.

### SUMMARY

There is a need for improved software application and workflow development tools that provide a simplistic and easy to use design environment that allows non-programmer domain experts and others to design and develop software and workflow applications.

The invention relates to an application development tool that allows a developer, such as a domain expert or any other person, to create applications graphically using a tree structure having a plurality of nodes connected by branches. Each node shown within a graphical user interface window represents a step in the being-developed application or developed application, such as a screen to be displayed to the user or an activity to be performed by the user or automatically performed when the application is executed. Thus, all of the nodes in the tree-editing environment when taken together translate into a step-by-step guide for a user of the developed application to complete a particular task or to reach a particular outcome. The plurality of nodes connect together to form a tree with branches between the nodes that represent the potential path(s) the user can take in the developed application.

The application development tool is a software application that when executed by a processor of a computing device allows the developer to create guidance trees through the graphical user interface window on a display of the computing device. The application development tool can be stored on a computer readable medium associated with the computing system. The computer readable medium can be one or more of RAM, ROM, flash memory, magnetic storage, and optical storage and/or any other storage used together with a computer system such as a general purpose desktop, laptop, or tablet computer.

Depending on the complexity of the task or problem to be solved, a tree can include numerous nodes and branches that have the potential to clutter the window and prevent the developer from seeing the entire guidance tree within the window in a practical manner. Large trees and limited screen space can result in the developer not being able to easily relate connected nodes or efficiently map the flow of the steps. In order to solve this problem, the inventive application development tool, upon selection of a node or step within a tree, automatically moves one or more nodes within the window, collapses one more branches of the tree and/or expands one or more other branches of the tree within the window to show the selected node and also one or more nodes before or after the selected nodes within the available space of the window without changing the size of the window. The ability to automatically adjust the size and content of a tree around a selected node allows a developer to seamlessly design the screenflow application without the use of browser tools and the need to manually collapse and expand branches. The automatic moving, collapsing, and expanding of graphical content is capable of focusing on a step without having to increase or decrease the actual size of the selected step. The application development tool thus essentially removes excess graphical content around the selected node within the window without having to use a zooming feature.

Once the developer creates a tree using the application development tool, the developer can publish the tree into the application defined by the plurality of nodes. The resulting application is often called a screenflow application because each screen or function performed in the developed application guides a user to an outcome through a particular path or flow. The nodes of the designing environment represent steps towards solving a problem or conducting a particular task in the executed application. In addition, a node can translate into an automatic step within the application. A node can also represent a data entry user interface to be displayed on a screen to a user when the application is executed. The data entry user interface allows the user of the application to enter data that can be processed and applied by the screenflow application. The screenflow application can represent a business process.

These and other aspects, features, details, and advantages of the invention will be better understood with reference to the following drawings and associated description. The drawings are not necessarily to scale, but are intended to convey concepts and details of the invention.

### BRIEF DESCRIPTION OF THE DRAWINGS

FIG. 1 is a flow diagram that generally depicts the steps from which the application development tool transfers a domain expert's knowledge to an end user.

FIG. 2 depicts a guidance tree created with the application development tool.

FIG. 3 illustrates the homepage of the application development tool software.

FIG. 4 depicts a guidance tree editing page.

FIG. 5 depicts a guidance tree properties box.

FIG. 6 is a flow diagram depicting step creation within a guidance tree using the application development tool.

FIG. 7 depicts a step information box.

FIG. 8 depicts the step information box of a screen step.

FIG. 9 depicts the screen step of FIG. 8 as it appears in the executed screenflow application.

FIG. 10 depicts the step information box for an automated step.

FIG. 11 shows the automated step of FIG. 10 with the screen input tab selected.

FIG. 12 is an example of FIG. 10 as actuated in the screenflow application.

FIG. 13 shows a portion of a guidance tree having a jump step.

FIG. 14 shows the step information box for a jump step.

FIG. 15 shows a portion of a guidance tree after “jumping” from the jump step of FIG. 13.

FIG. 16 shows a step information box for an end step.

FIG. 17 depicts the end step of FIG. 16 as actuated in the screenflow application.

FIG. 18 depicts the embedded guide step of FIG. 19 within a guidance tree.

FIG. 19 shows the step instruction box for an embedded guide step.

FIG. 20 shows the resulting screen after clicking the name of the linked or imported guidance tree.

FIG. 21 shows the step information box for a data decision step.

FIG. 22 shows the data decision step from FIG. 21.

FIG. 23 depicts a placeholder step within a guidance tree.

FIG. 24 depicts a guidance tree hierarchy view.

FIGS. 25A and 25B exemplify the automatic expanding, collapsing, and moving of the graphical content of the guidance tree within a display window of a computing device.

FIGS. 26A and 26B exemplify the automatic expanding, collapsing, and moving of the graphical content of the guidance tree within a display window of a computing device.

FIG. 27A depicts an example of a completed guidance tree.

FIG. 27B-27E are screenshots of the resultant screenflow application from the completed guidance tree in FIG. 27A.

FIG. 28 is a schematic diagram depicting a network based environment in which screenflow developers connect to an application development tool and screenflow server and database in order to, for example, run the application development tool to build guidance trees, and end users connect to the application development tool and screenflow server to, for example, run screenflow applications.

FIG. 29 is a schematic diagram depicting a sales associate using a computing device to access the screenflow server and database to run a screenflow for step-by-step guidance during a customer phone call.

FIG. 30 depicts some of the basic structural and functional components of any computing device used by screenflow developers and end users to connect via a computer network to the application development tool and screenflow servers and databases.

### DESCRIPTION

The application development tool of the invention is a platform for designing and publishing applications that guide a user to a desired outcome, i.e. to guide workflow. The designed application, called a screenflow, guides a user through multiple screens until the user reaches the outcome. The application development tool has a tree structure editing environment. The tree has a single starting node that branches to other nodes and each node represents a step in the workflow that will eventually lead to an outcome in the resulting screenflow application. The branched nodes, or steps, can lead to the same outcome or different outcomes from the different branched paths. When working with the tree structure, every step in the tree can also serve as shorthand for all the subsequent branched steps. The trees are often called guidance trees because the trees transform into a screenflow application that guides a user through a set of questions, instructions, and automated steps.

A particular advantage of guidance trees is that the developer is able to transfer their knowledge and expertise on a topic to an end user in a manner that easily allows an end user of the created application to do and when. The principal behind the screenflow designer and resulting application is to transfer knowledge from an expert to a non-expert through a series of questions, much like the Socratic method. The Socratic method is a pedagogical technique of leading a student to the truth through a series of questions. The desired outcomes include, but are not limited to, problem solving or directing an end user to successfully complete a task through situational-based instructions.

The developer of a guidance tree does not have to be or require the assistance of a software programmer because each node, or step, simply requires the developer to fill in information and/or data fields and the program automatically generates the next step. The process is repeated until the developer choses an end step. Each step a developer creates represents either a screen to be displayed to an end user during execution of the application or an activity to be performed during execution of the application. The nodes within the graphical user interface window are synonymous with the term step because the nodes simply are a graphical representation of a step in the resulting screenflow application.

The application development tool allows the developer to create guidance trees through a graphical user interface window on a display of the computing device. Depending on the complexity of the task or problem to be solved, the tree can amass numerous steps and branches that can clutter the window and can prevent the developer from seeing the entire guidance tree within the window in a practical manner. Large trees and limited screen space result in the developer not being able to easily relate connected steps or efficiently map the flow of the steps. In order to solve this problem, the application development tool upon selecting a step within a guidance tree automatically moves one or more steps within the window and collapses one more branches of the tree and expands one or more other branches of the tree within the window to show the selected step and also one or more nodes before or after the selected step within the available space of the window without changing the size of the window. The ability to automatically adjust the size and content of a tree around a selected step allows a developer to seamlessly design the screenflow application without the use of browser tools and manual collapsing and expanding of branches.

Certain tree display and navigation arrangements are generally known in the art. See, for example, U.S. Pat. Nos. 7,360,175 and 7,627,599. See also, for example, the University of Maryland's node-link tree browser described in the publication: “SpaceTree: Supporting Exploration in Large Node Link Tree, Design Evolution and Empirical Evaluation” by Catherine Plaisant, Jesse Grosjean, and Benjamin B. Bederson of the University of Maryland's Human-Computer Interaction Laboratory (Proceedings of IEE Symposium on Information Visualization, 2002, pp. 57-64, Boston, October 2002). However, such tree display and navigation arrangements require re-scaling of the tree to fit the available screen space. The prior art tree display and navigation arrangements do not provide for automatically moving nodes, collapsing branches, and expanding branches to show the selected node and one or more nodes before and after the selected node. In addition, the prior art tree display and navigation arrangements have not been used for an editing environment for developing applications.

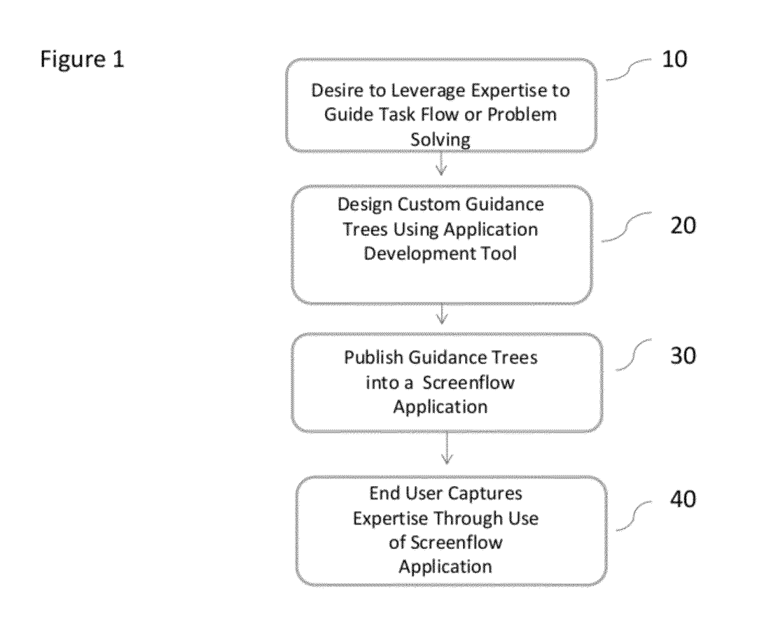

FIG. 1 generally depicts the steps from which the application development tool transfers a domain expert's knowledge and skill to an end user. Step 10 involves a desire to leverage knowledge to guide task flow or problem solving. Step 20 involves designing a customized guidance tree utilizing the application development tool. Step 30 involves publishing the guidance tree into a screenflow application. Step 40 involves an end user solving problems and performing task with the domain expert's guidance and knowledge through use of the guidance tree screenflow application.

The first step 10 involves the desire to leverage a domain expert's knowledge to guide another's task flow or problem solving. A domain expert is a person who is expert in a particular area or topic. Often companies want to transfer the know-how of an employee with the most experience in a manner that allows any other employee to easily know what to do and when. The ultimate goal is to allow one with limited knowledge of a problem or subject matter to solve a problem or complete a task with the same efficiency as the expert.

A company can utilize a domain expert's knowledge to assist others in diagnosing hardware, navigating tax refunds, directing sale promotions or marketing, and guiding customer service. For example, less knowledgeable technical support employees are not able to answer customers' technical problems as efficiently as a highly skilled and more experienced employee. A screenflow application utilizing the domain expert's knowledge allows the less knowledgeable technical support employee to solve the customer's problems by following situational based steps created by the domain expert. In addition, sale promotions are often very detailed oriented and taking the time to train a sales associate on every aspect of the promotion is not an option. Instead of training employees on how to conduct the sales promotion, the company can provide the employees with a step-by-step prose for the sales promotion based on situation specific answers using a screenflow application.

Although the application development tool and resulting screenflow application can be utilized to leverage expertise to guide task flow or problem solving, the application development tool can also be utilized to create, for example, a game, such as twenty questions, or a choose your own ending online book. The tool can also be utilized to make decision trees that allow one to make decisions based known data.

The second step 20 consists of developing a customized guidance tree using the application development tool of the invention to transform the domain expert's knowledge into a screenflow application. The application development tool is simple enough that non-programming experts are able to design a screenflow that captures their knowledge. This removes the need for and expense of a programmer and allows the domain expert to create, update, or edit their captured expertise application at any time. Through the application development tool, the domain expert becomes the developer of the screenflow application.

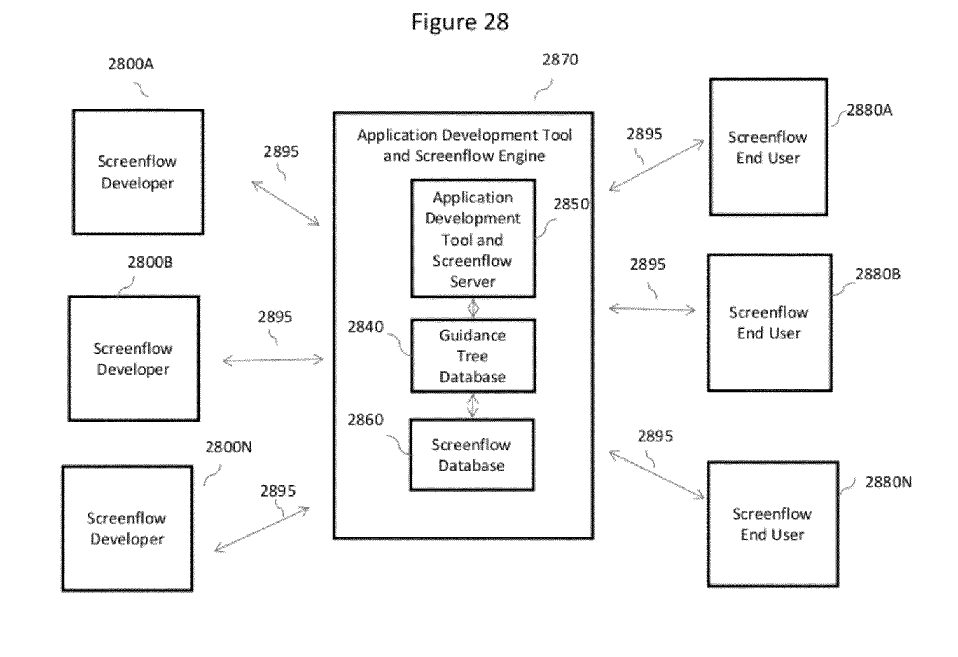

A network-based environment allows screenflow developers to use the application development tool to create and share guidance trees and developed screenflow applications that can be easily accessed over the network by other developers and any end users. FIG. 28 depicts screenflow developers 2800A, B, . . . N connected over a computer network 2895 to an application development tool and screenflow engine 2870 that allows the developer to design guidance trees and publish guidance trees into screenflow applications so that end users 2880A, B, . . . N also connected over the computer network 2895 to the engine 2870 can access and run the screenflow application.

The application development tool and screenflow engine 2870 includes at least one application development tool and screenflow server 2850, such as the ActiveVOS Central Server. In addition, the engine 2870 includes at least one guidance tree database 2840 and at least one screenflow database 2860 that store created guidance trees and corresponding screenflow applications as well as other data, such as runtime data, pre-defined data fields and corresponding data, customized data fields and data entered from the developer, and end user input data. The server 2850, for example, provides for execution of procedures, such as programs, routines, scripts, for supporting the application development tool, managing and coordinating all processes, executing any procedures associated with screenflow applications, interpreting processes definitions, and communicating with end users.

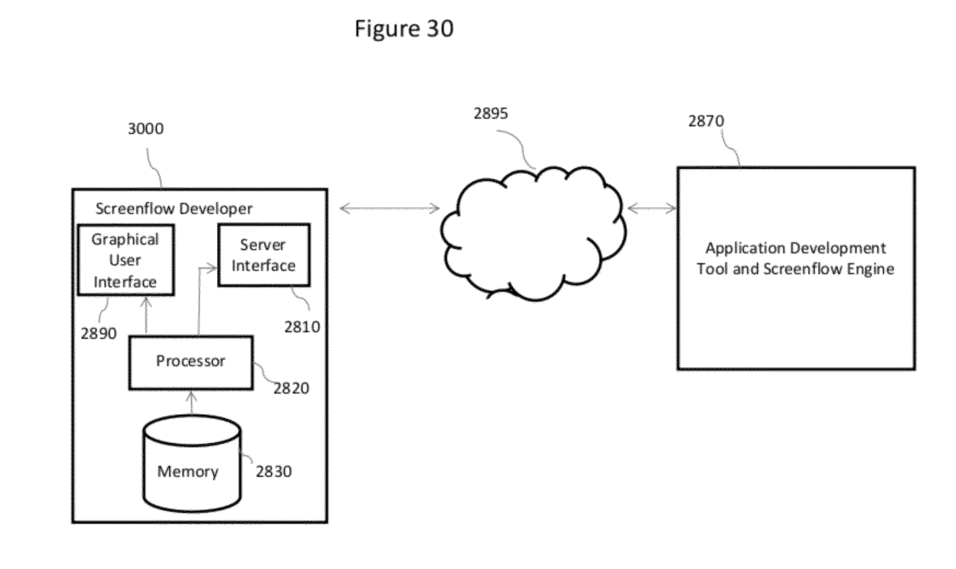

Each screenflow developer 2800A, B, . . . N uses a computing device to design guidance trees and each end user 2880A, B, . . . N uses a computing device to run screenflow applications. FIG. 30 depicts the basic function and structural aspect of an exemplary computing device 3000 for use by screenflow developers 2800A, B, . . . N and end users 2880A, B, . . . N . . . . The computing device 3000 has at least one processor 2820, a server interface 2810, a graphical user interface 2890, and some type of storage device 2830 such as computer-readable memory. Examples of computing devices include but are not limited to a computer, a workstation, a laptop, a notebook, smart phones, and tablet computers. The storage device 2830 can include one or more permanent and/or temporary storages such as, for example, a hard disk, ROM, flash memory, RAM, and one or more other types of electronic, electro-mechanical, and/or electro-optical computer storage components. The storage device 2830 contains the application development tool and screenflow software, which when executed by the processor, can allow the developer to create guidance trees or can allow the end user to run screenflow applications through the graphical user interface 2890. The application development tool software can run on operating systems, such as, Microsoft, Apple, Android, Blackberry, or Linux operating system. Through the server interface 2810, the computing device 3000 connects over a computer network 2895 to the application development tool and screenflow engine 2870. The screenflow developers 2800A, B, . . . N and end users 2880A, B, . . . N using computing devices 3000 can connect via a computer network 2895 to the server using any type of network connection, such as a local area network or wide area network.

The screenflow developers 2800A, B, . . . N connect to the engine 2870 to design, develop, and share guidance trees as well as publish guidance trees into screenflow applications to share with end users 2880A, B, . . . N. The screenflow developers 2800A, B, . . . N can also share guidance trees with other developers. For example, developer A can design and save a guidance tree X on the engine 2870, and developer B can access the engine 2870 to open and make edits to guidance tree X. The server 2850 executes all the processes required to design, share and publish guidance trees. The guidance tree database 2840 stores in-development guidance trees. Guidance trees can be expressed in any of a number of markup languages (e.g., XML, HTML, WML, CHTML) known in the art or other computer languages (e.g., Java) known in the art. The screenflow developer 2800 can transfer completed guidance trees through the server interface 2810 to the engine 2870, in which the engine 2870 transforms the guidance tree into the screenflow application. In certain aspects, the screenflow developer transforms the guidance tree into a screenflow application prior to transfer to the server. The resulting screenflow applications can be expressed in any of a number of markup languages (e.g., XML, HTML, WML, CHTML) known in the art or other computer languages (e.g., Java) known in the art.

The screenflow end users 2880A, B, . . . N connect to the engine 2870 to access and run screenflow applications. The screenflow end users can execute screenflow application programming interfaces to run any one of the screenflow applications. The server 2850 executes all processes required to run the screenflow application, for example, runs automated steps, receives and processes any data inputted into the screenflow from the screenflow end user, and collects runtime data and usage report. The screenflow database 2860 contains, for example, screenflow applications for end users to access, saved running screenflow applications, and data collected or entered into a screenflow during execution.

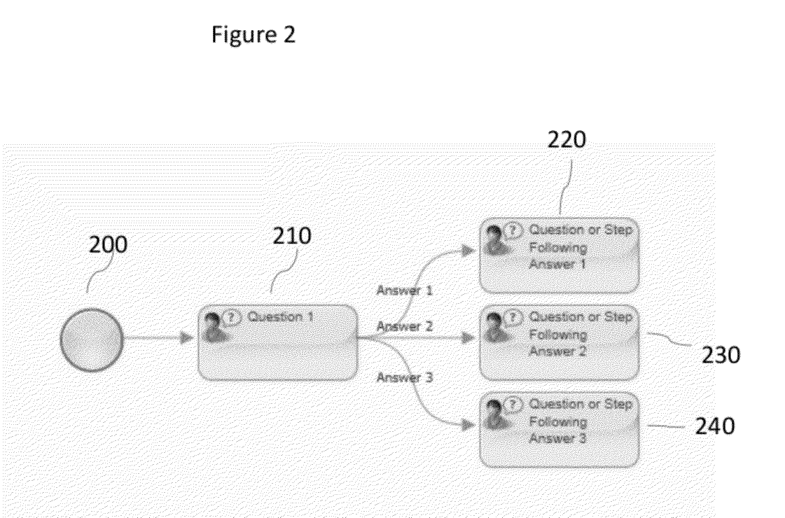

FIG. 2 depicts an example of a guidance tree that a developer can create using the application development tool. A start circle 200 indicates the beginning of the guidance tree. If the developer double clicks on the start circle 200, a window appears in which the developer can input data about the guidance tree, such as a title and a brief description about the tree. Every start circle 200 is linked to a start step 210. The start step 210 initiates screenflow. By double clicking on the start step 210, an instruction window appears in which the developer can pose a question and can provide one or more answers to the question. The answers lead to the next step or node in the guidance tree. As shown in FIG. 2, three answers were given to question presented in step 210. Based on the answers provided in start step 210, the application development tool automatically generated three new steps 220, 230, and 240 that are linked to the start step 210 by branches. Accompanying each branch is the text of the answer that led to the next step. This allows the developer to easily keep track of the workflow. For each of the new steps 220, 230, 240, the developer can pose another question that leads to further steps, create an automated step, or provide an answer or outcome, i.e. create an end step.

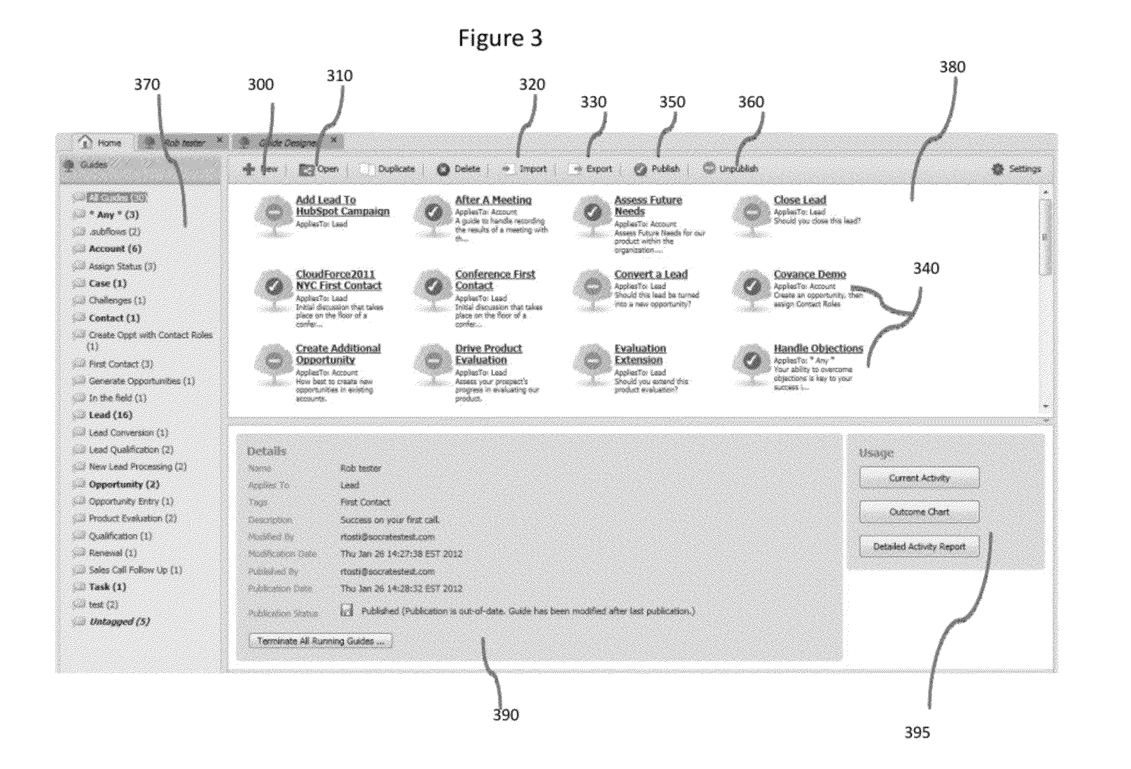

FIG. 3 illustrates a homepage of the application development tool software. From the homepage, the developer can click on the New 300 icon to begin a new guidance tree. The Open 310 icon allows a developer to open previously saved guidance trees. The Import 320 and Export 330 icons allow the developer to import and export guidance trees made using the application development tool. Guidance tree folders 370 are provided on the side of the homepage to provide easy access to saved guidance trees. Clicking on a guidance tree folder displays the guidance trees icons 340 in screen 380. Clicking on a guidance tree icon 340 within screen 380 allows the developer to see the selected guidance tree's details 390. The details 390 can include, for example, the name of the guidance tree, a tag for the guidance tree, the description of the guidance tree, the name of the person who last modified or edited the tree, the modification date, the name of the person who last published the guidance tree, the publication date, the publication status, an URL to start the publication's screenflow, and embedded code that allows one to embed a screenflow in a website using a copy and paste function.

The homepage as shown in FIG. 3 also displays the usage section 395 for the selected guidance tree. The usage section 395 allows the developer to see how end users are using the created screenflow application of the published guidance tree. The current activity report shows a snapshot for all actively running instances of the screenflow. This can include the name of the user who started the screenflow and the step the user is currently executing. Another feature of the usage section 395 is the outcome chart. The outcome chart charts all the outcomes users arrived to by completing the screenflow. If the guidance tree was designed to have more than one outcome, the outcome chart shows what percentage of completed screenflows resulted in each outcome. A developer can also access a detailed activity report. The detail activity report provides details about running and completed screenflows. It shows the number of screenflow instances that have run, who ran the screenflow, the duration of each screenflow run, and the outcome of the screenflow run. Because the application development tool allows work-in-progress editing, if a developer sees that a screenflow is running in either the current activity or the detailed activity report, the developer can select the step currently being accessed by a user in the screenflow and be directed to that step within the tree editing design environment. The developer can edit the step without disrupting the end user's use of the screenflow application.

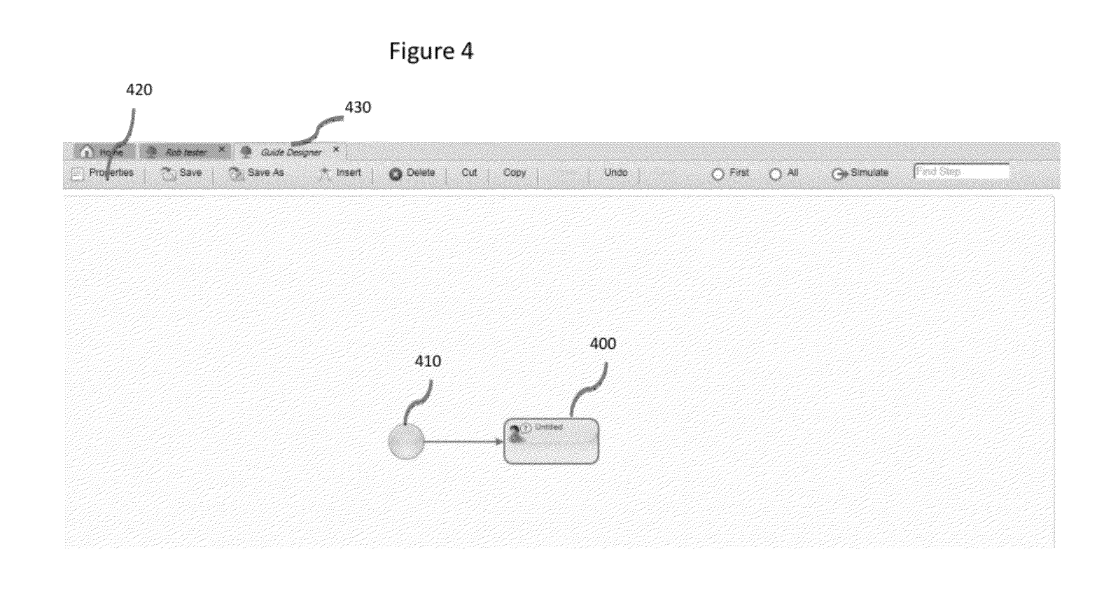

In order to start a new screenflow, the developer clicks the new icon 300 from the homepage as shown in FIG. 3. By clicking the new icon 300, a guidance tree editing page 430 appears, as shown in FIG. 4. Upon first entering the guidance tree editing page 430, a start step 400 can either appear automatically or the software can be programmed to require a manual inserting a start step. Connected to the start step 400 is a start circle 410, which indicates the beginning of the guidance tree. By double clicking the start circle 410 a guidance tree properties box will appear. The user can also access the guidance tree properties by clicking the properties icon 420. In certain aspects the guidance tree properties box will automatically appear as soon as the developer enters the new guidance tree editing page 430.

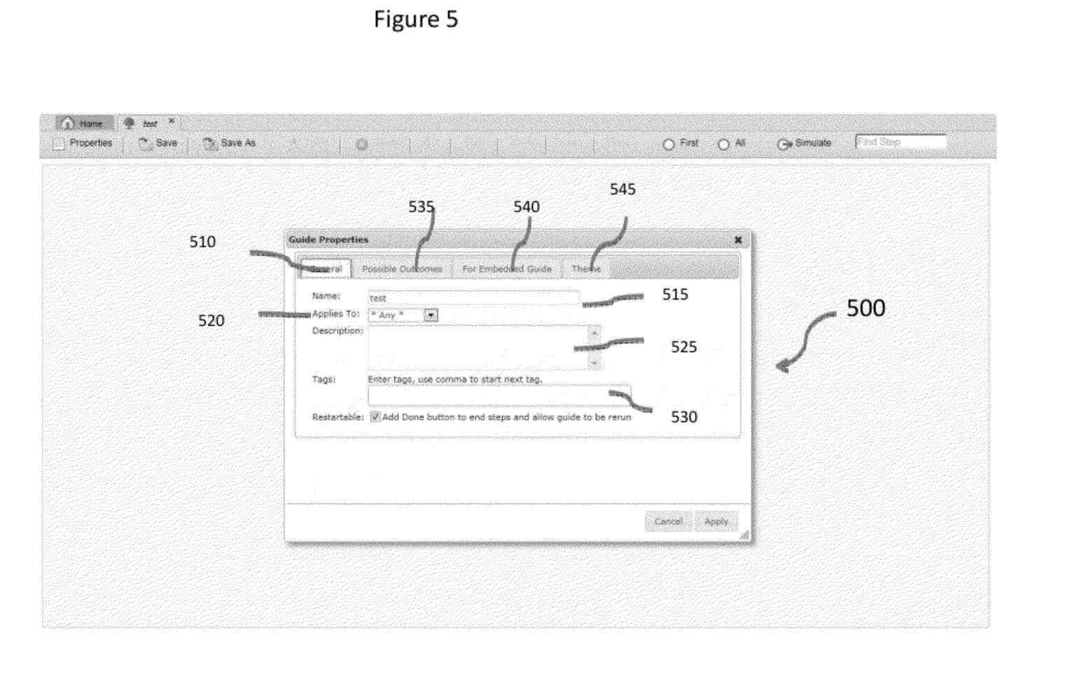

FIG. 5 shows the guidance tree properties box 500. The guidance tree properties box 500 prompts the developer to provide general information within the general tab 510 about the current guidance tree, such as the Name 515 of the guidance tree, the type of guidance tree the current guidance tree “Applies To” 520, a Description 525 of the guidance tree, and Tags 530 of the guidance tree. In addition, the guidance tree properties box 500 provides an option for a Done button to appear on any created end steps. The Done button allows the end user to exit the executed screenflow application upon completion.

The application development tool provides a listing of common types of guidance trees often in the Applies To 520 drop box. Within the Applies To 520 drop box, the developer selects what type of guidance tree the current tree best “applies to.” This allows for easy classification of the guidance tree and provides the developer access to predefined data fields that are associated with the certain type of guidance tree. Applies To 520 guidance tree types include but are not limited to account, campaign, case, contact, contract, document, event, feed item, lead, note, opportunity, product, and task.

Within the Tags 530 entry box, a developer can enter descriptive words that categorize the guidance tree. Within the Description 525 entry box, the developer can enter a detailed description to describe the guidance tree. Both the Tags 530 and the Description 525 provide additional detail beyond the Applies To 520 type that are helpful in describing to the content of the guidance tree without having to open the guidance tree. The Tags 530 and Description 525 show up when opening guidance trees in the guidance tree's details 390 as shown in FIG. 3.

The guide property box 500 also includes a Possible Outcomes tab 535. The possible outcomes tab 535 allows a developer to enter in the desired outcomes of the guidance tree. The embedded guide tab 540 allows a developer to control how other guidance trees can be connected to the current guidance tree and how the current guidance tree is exported into other guides. In addition the guide property box 500 has a theme tab 545 that provides different stylistic format options for the guidance tree.

After the guidance tree properties are set, the developer can design a guidance tree through the creation of steps that translate into action steps within the screenflow. The steps appear as nodes interconnected by branches within the graphical user interface to form the tree structure.

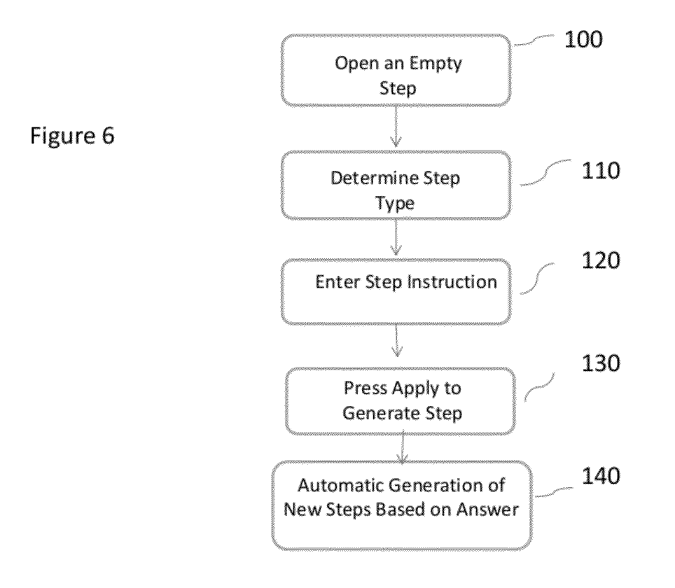

FIG. 6 is a flow diagram depicting the creation of a step within a guidance tree using the application development tool. In Block 100, the developer opens a step. The step can be a start step, a subsequent step that was automatically generated based on answers to a previous step, or a step manually inserted into the guidance tree. The start step and all subsequent steps are created through the process outlined in FIG. 6. In Block 110, the developer determines the type of step. At Block 120, the developer can enter step instructions, a prompt and potential outcomes or answers to the prompt. Step instructions are dependent on step type and can include one or more of providing background information, inserting read only data fields and/or input data fields, adding automated tasks, linking to other steps or guidance trees, and inserting data decision fields. At Block 130, the developer clicks apply to generate the step. After clicking apply, the application development tool automatically generates new empty steps based on the previous step as indicated in Block 140.

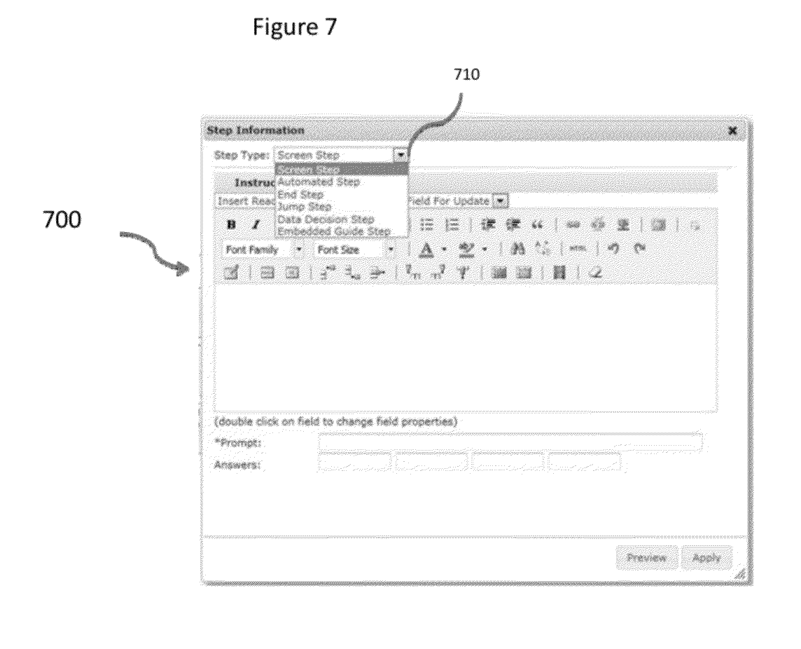

To begin a guidance tree, a developer needs to turn the first step into an actionable step following process depicted in FIG. 6. The first step within a guidance tree is called a start step. For example, by double clicking the start step 400, as shown in FIG. 4, a step information box 700 appears as shown in FIG. 7. The developer can enter instructions within the step information box 700 that transform the start step 400 to an actionable step within the guidance tree. From the start step, the developer can create add as many branches that can lead to as many outcomes as the developer wants by following the process for FIG. 6 for each step created in the guidance tree.

FIG. 7 depicts a step information box 700. Through the step information box 700, the developer transforms an empty step into an actionable step within the resulting screenflow application. Information inputted into the step information box 700 transforms the step into an screen to be displayed to an end user when the application is executed or an activity to be performed when the application is executed. Within the step information box 700, the developer can select a step type by choosing a step type from the step type drop box 710. FIG. 7 shows the step type drop box 710 opened displaying the different types of guidance tree steps a developer can choose from within the application development tool. The types of steps include a screen step, an automated step, an end step, a jump step, a data decision step, and an embedded guide step. Below the creation of each type of step is discussed in detail. Step creation is the generally the same regardless of the location of the step within the guidance tree. The format of the step information box 700 automatically changes its display format and content depending on the step type selected.

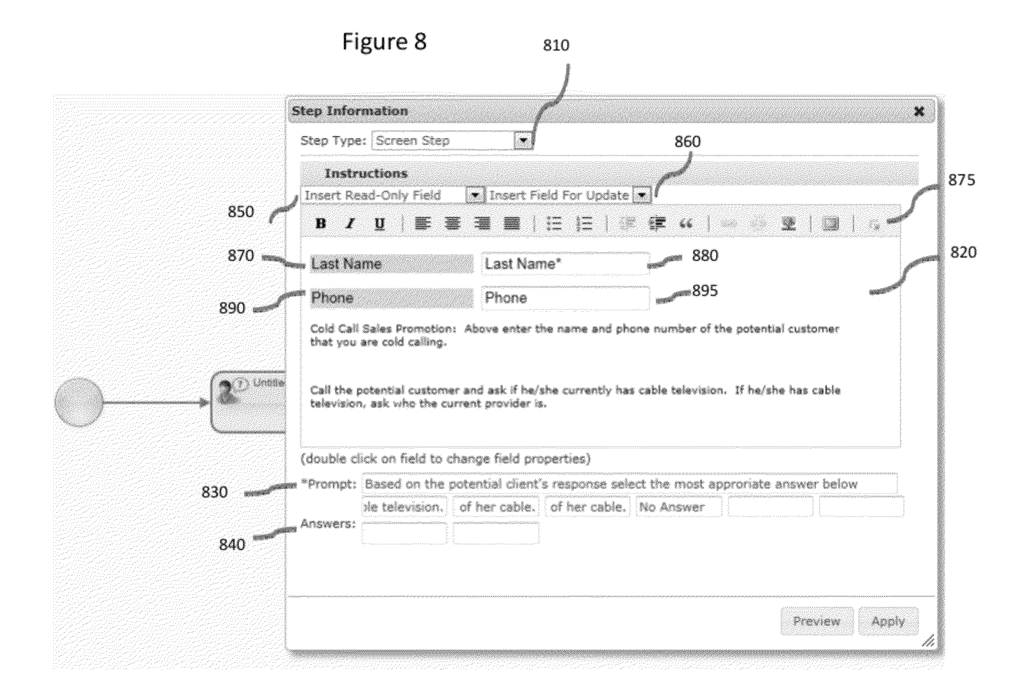

FIG. 8 depicts the step information box for a screen step. The screen step 810 is chosen within the step type drop box 710. The step information box for a screen step 810 includes but is not limited to an instruction section 820, a prompt 830 and answer entries 840. Within the instruction section 820, the developer can enter any information he/she wants to convey to the end user of the screenflow application. For example, the developer can write a description, enter a table, a hyperlink, a graphic, read-only data fields, input data fields, and embedded media, such as a video file. Tables, graphics, and embedded media can be entered into the instruction section 820 through the instruction section tool box 875.

The developer can also enter data for the screenflow application within the screen step by inserting read-only data fields 850 and input data fields 860. The data appears within the step upon execution of the screenflow application. The application development tool contains pre-programmed data fields for each guidance tree type that recognizes and finds data for the field. If the developer enters a read-only data field for a specific field type, the application development tool will automatically locate the data for the field type from a data source, i.e. a pre-defined data source or an online data source, and display the found data within the screen to the end user when the application is executed. If the developer enters an input data field box, a data entry user interface will appear on the screen upon execution of the program in the form of a data entry box. The end user can then input data into the data entry box. The application development tool recognizes the data placed into the data entry box for the field and can, for example, apply the data entry input for the field to other steps, within other guidance trees, add the data entry input to the pre-defined data source, and/or can enter the data into a stored data profile for the specific guidance tree, i.e. a customer profile. In other aspects, data entered into the input data field will automatically replace and update previous data for the field in the pre-defined data source.

For example, in FIG. 8, two read-only fields and corresponding input fields were inserted in the instruction section 820: Last Name Read Only Data Field 870, Last Name Input Data Field 880, Phone Read Only Data Field 890 and Phone Input Data Field 895. Inserting the Last Name Read Only Data Field 870 within the screen step instruction box causes the executed screenflow application to automatically look up the Last Name within a predefined data source and will display the name on the screen to the user. The same applies for the Phone Read Only Data Field 890. Inserting the Last Name Input Data Field 880 within the screen step instruction box causes the executed screenflow application to display a data entry box within the screen of the executed screenflow application. The Last Name Input Data Field 880 allows the end user to enter or add data to the pre-defined data source or update the pre-defined data source while running the screenflow application. The same applies for the Phone Input Data Field 895.

In addition to adding read-only and input data fields within the screen step, the developer can also provide background information within the instruction section 820 for the prompt 830. In FIG. 8, for example, the background information asks the end user to fill in the name and phone number of the potential customer. The developer also sets up the prompt 830 by giving the end user a task to call the potential customer in order to ask whether he/she has cable and, if yes, who the current provider is. For the prompt 830, the developer can place meaningful description of the step to lead the end user to select one of the answer entries 840. Because each screenflow is unique and customized by the developer, the prompt can be any description that encourages the end user to continue to the next step through the answers. The answer entries 840 become clickable buttons within the screenflow application that lead the end user to the next step. For example, the prompt can pose a true or false question and the answers can be true or false. In another example, the prompt may merely state “Press Continue” and the answer is “Continue.” As exemplified in FIG. 8, the prompt 830 asks the user to select the most appropriate answer out of the given answers 840 in light of the task given in the instruction section 820.

When the developer finishes filling in the step information box, the developer can press preview to view the screen step as it will appear in the screenflow application.

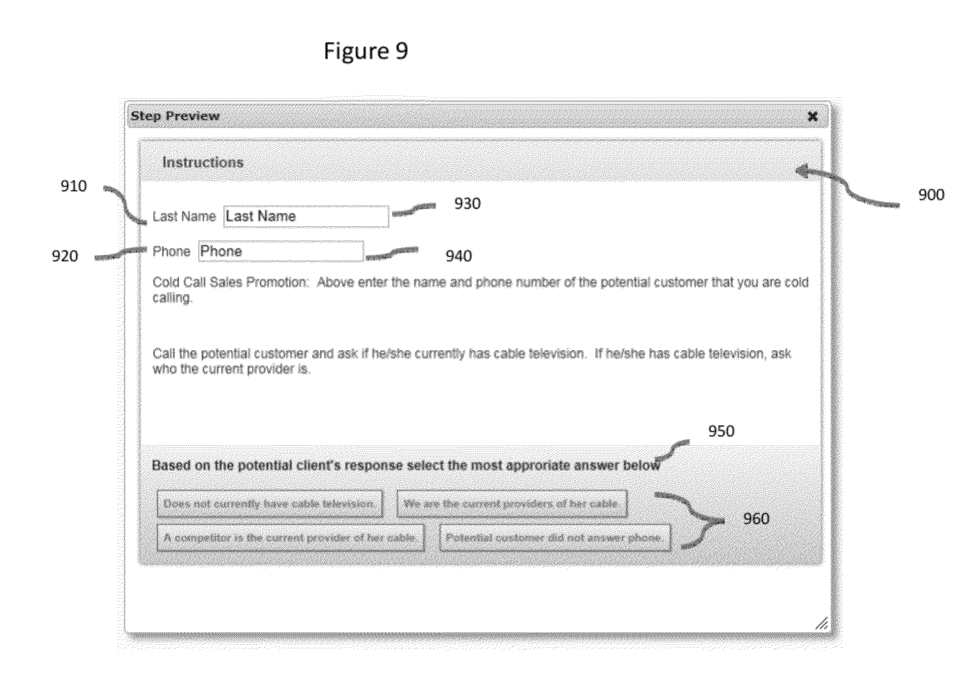

FIG. 9 depicts the screen step of FIG. 8 as it appears in the executed screenflow application. The screen step appears as an instruction box 900 containing the information and data fields that the developer placed into the instruction section 820. Last Name Read Only Field 870 and Phone Read Only Field 890 turn into Last Name 910 and Phone 920. Last Name Input Field 880 and Phone Input Field 895 turn into a Last Name data entry box 930 and Phone data entry box 940. The prompt entry 830 turns into a prompt 950. The answer entries 840 turn in to clickable answer buttons 960. When the end user clicks an answer button 960, the end user is taken to the next step within the screenflow application that corresponds with the answer.

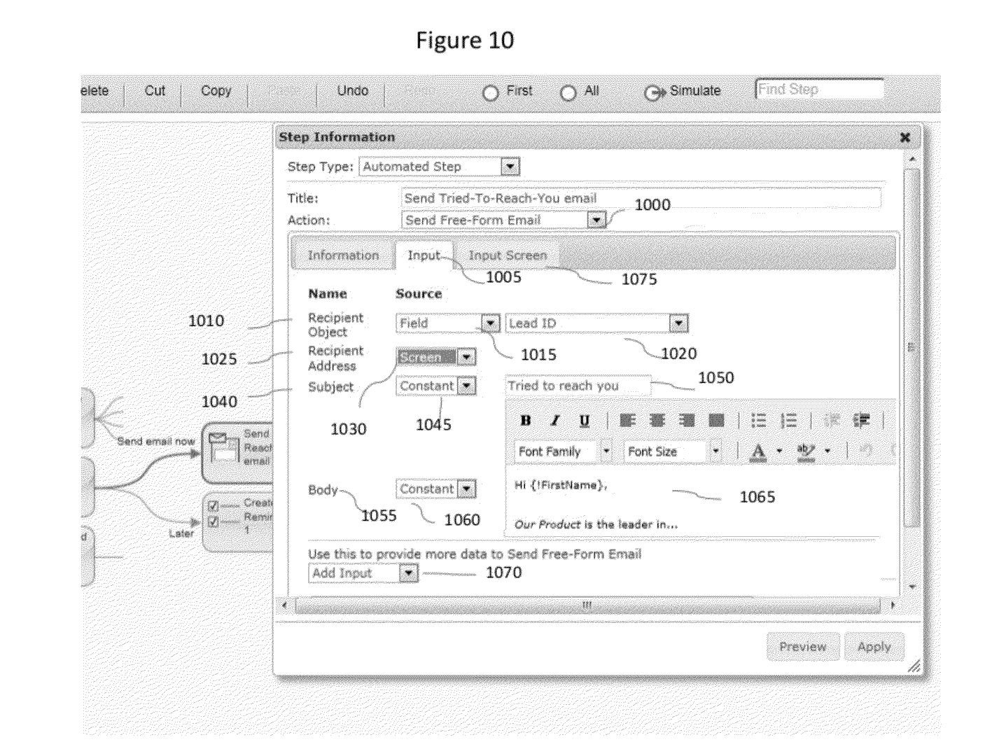

An automated step is a step that performs an activity within the screenflow application without involving the end user. Examples of automated steps include running system tests, getting customer information, or changing the status of a work in progress. FIG. 10 exemplifies the step information box for an automated step. For each automated step, the developer can choose an action type 1000 within the step information box. The application development tool software has pre-defined action types 1000 for some automated steps, or the developer can create custom action types for automated steps. Custom action types can be created using Eclipse-based development environments. Custom automated steps can be created to conduct arbitrary calculations, such as tax calculations, or integrate data within the guidance tree from external programs or systems.

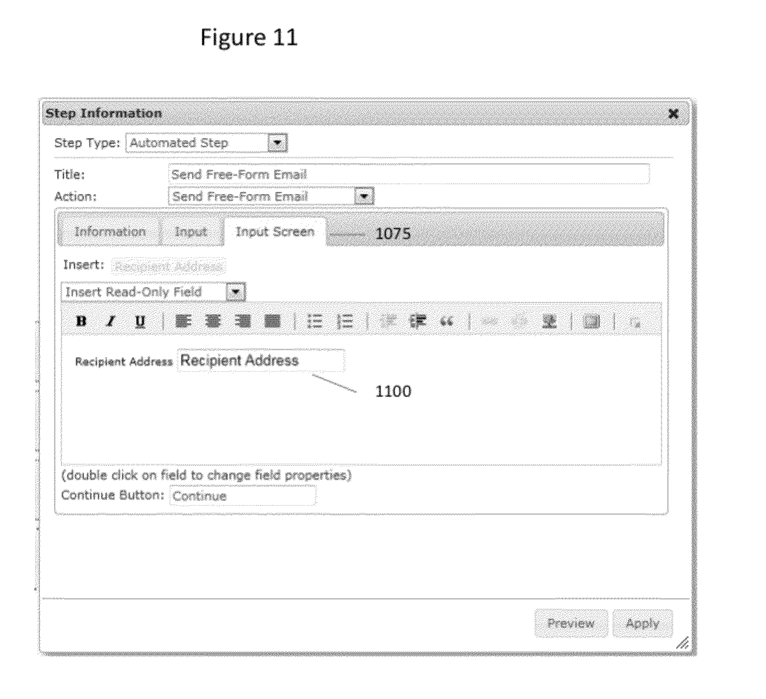

After the action type 1000 is selected, the developer can enter information into the input tab 1005 that turns the automated step into an actionable step in the executed application. In certain aspects, after the action type 1000 is selected, the data fields within the input tab 1005 automatically change to data fields that are specific to the action type 1000. The data fields provide any information needed to perform the action type 1000. Accompanying each data field is the source of the data and the data content. The developer of the automated step can determine which source of data to use. Types of data sources include constant, screen, and field. A constant data source type is set by the developer of the automated step, and is not dependent on other variables. Whereas selecting a field data source type creates a read-only field, just like the read-only fields of the screen step, that identify and collect data based on the pre-defined data source or information defined within a previous step. The screen data source type allows developer to insert input data fields within the automated step just like the input data fields of the screen step. If the developer chooses a screen data type, information for the screen data source is entered within the input screen tab 1075. Placing an input data field within the input screen tab 1075 causes a data entry user interface to appear on the screen of the executed application. In certain aspects, if a screen data source type is placed within an automated step, the step will not perform the automatic action until the end user inputs data in the data entry user interface. FIG. 11 shows the automated step with the screen input tab selected.

The automated step runs the processes needed to complete the step action incorporating the data field information and then updates the guidance tree data so that the results of the automated steps will be shown to the end user at run time. The application development tool is designed to manipulate XML data, deal with exceptions, timeouts and events, and handle any complexities of interfacing with external systems that might occur while carrying out the automated step. Like a screen step, the automated step can have multiple potential answers, but the answer path that will be taken when it runs is determined by the system instead of the answer chosen by the end user.

FIG. 10 is an example of the step information box for an automated step with the action step “Send Free-Form Email” 1000 selected. Within the input tab 1005, the developer is shown the different types of data fields specific to the “Send Free-Form Email” action type 1000. Examples of data fields specific to the “Send Free-Form Email” action type 1000 can include Recipient Object 1010, Recipient Address 1025, Subject 1040, and Body 1055. Other data fields specific to the “Send Free-Form Email” action type can be added using the Add Input 1070 drop down box. For the Recipient Object 1010 data field, the selected data source is a field data source 1015 having “Lead ID” as the field name 1020. The application development tool will automatically look for data relating to the “Lead ID” to correspond to the Recipient Object. The data source accompanying Recipient Address 1025 is a screen data source 1030. For the screen data source 1030, the developer can enter an input data field within input screen tab 1075 to correspond with the Recipient Address. As shown in FIG. 11, the developer entered an input data field for Recipient Address 1100 within the input screen tab 1075. If an end user was running this screenflow, the end user will be asked to enter the email address of the intended recipient in a data entry box prior to the automated step. The Subject 1040 and Body 1055 are listed as constant data fields in FIG. 10. This means that the subject text 1050 and body text 1065 provided by the developer in the step instruction box will appear in the email sent automatically by the automated step.

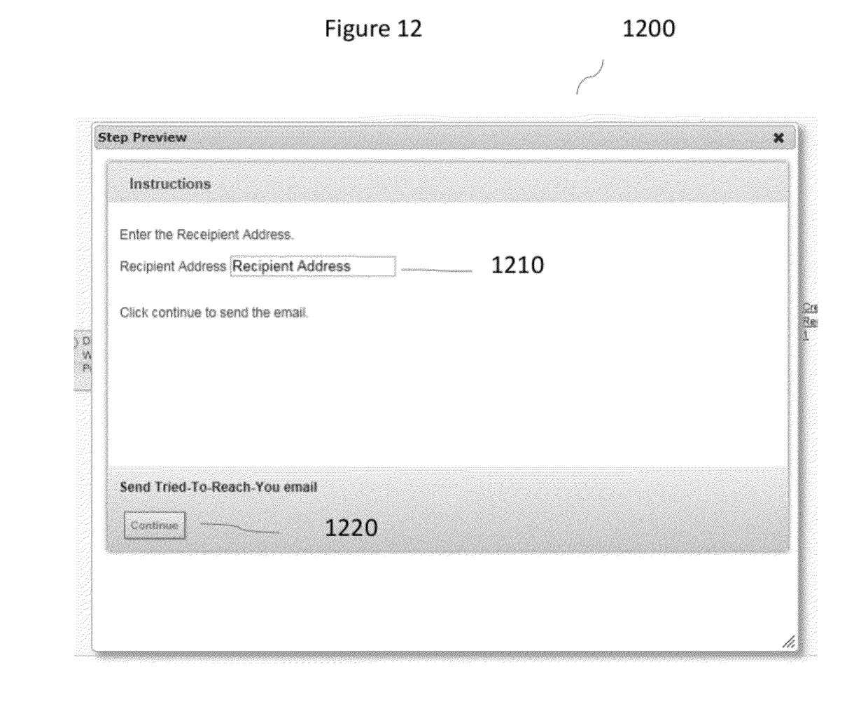

FIG. 12 is an example of FIG. 10 as actuated in the screenflow application. Because the Subject 1040 and the Body 1055 of the email were identified as constant data sources, the end user does not have to write the email. The end user simply has to input the intended email address in the Recipient Address data entry box 1210. When the end user clicks continue 1220, the automated step automatically performs the processes required to send the email.

Jump steps allow the developer of a guidance tree quickly jump to another branch or step within a guidance tree. The jump step is labeled with the step it will jump to and the designer can click on the label and go there. The application development tool can but does not require showing the actual linear connection between the jump steps. Not showing the lines between jump steps allows the developer to focus on the main paths of steps he/she is working on and the desired outcome of the guidance tree rather than losing focus because of a multitude of connecting lines. In addition, jumps steps automatically direct the end user to the jumped to step while running the screenflow application without having to go through steps that lead to the jumped to step.

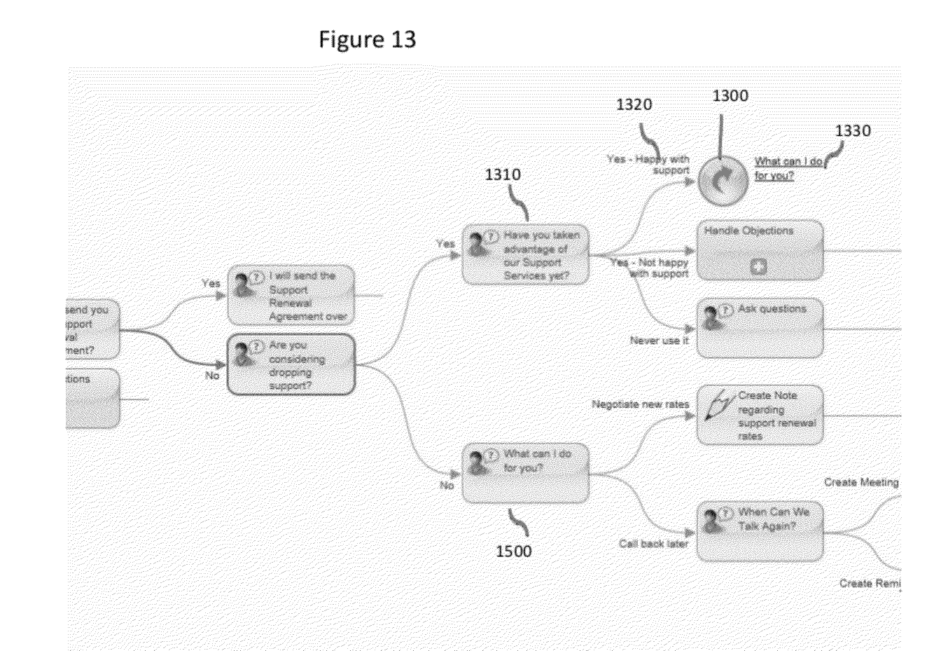

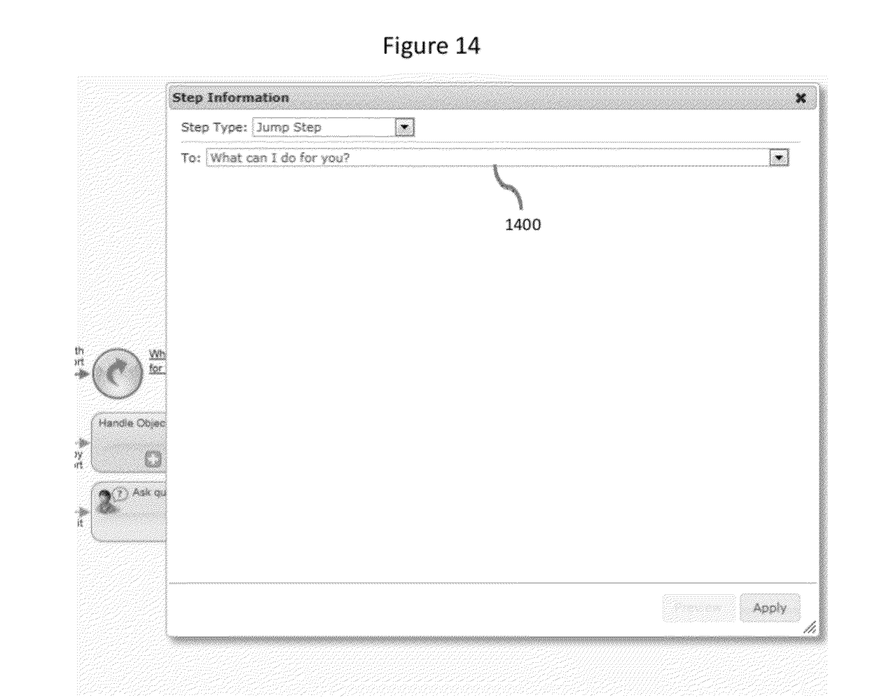

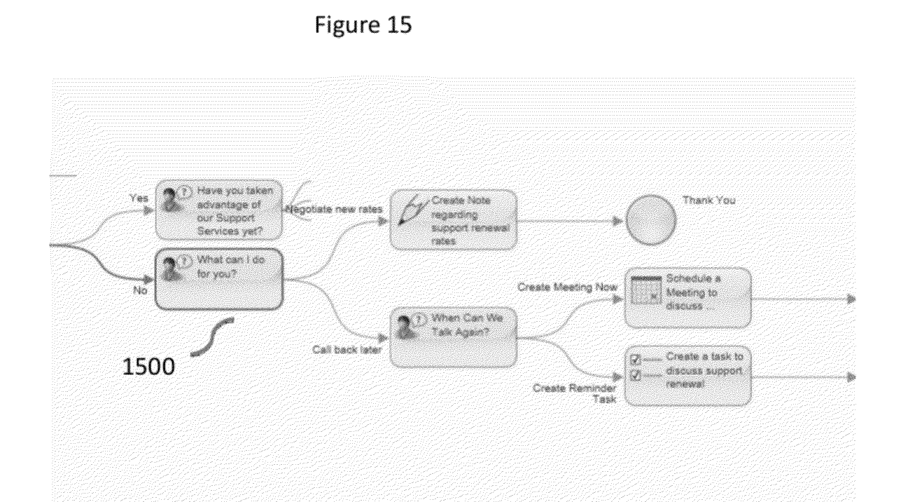

FIG. 13 shows a portion of a guidance tree having a jump step 1300. If the end user selects answer 1320 within preceding step 1310 that leads to jump step 1300, the screenflow will automatically direct the end user to the step listed within the step information box for the jump step 1300. FIG. 14 shows the step information box for a jump step. Upon clicking the jump step drop box 1400, the jump step drop box 1400 will display all of the steps created within the tree. To create a jump step, the developer selects a step in the jump step drop box 1400 and presses apply. As depicted in FIG. 13, after creation of the jump step, the jump step is shown with a link 1330 to the selected jumped to step 1500. When building the tree, if the developer clicks on the link 1330 the developer is automatically directed to the jumped to step 1500, as shown in FIGS. 13 and 15. The guidance tree branch flow as shown in FIG. 13 for the jump step 1300 collapses, and the guidance tree branch flow for the jumped to step 1500 expands and is displayed to the developer. This allows the developer to quickly access any steps that flow from the jumped to step 1500.

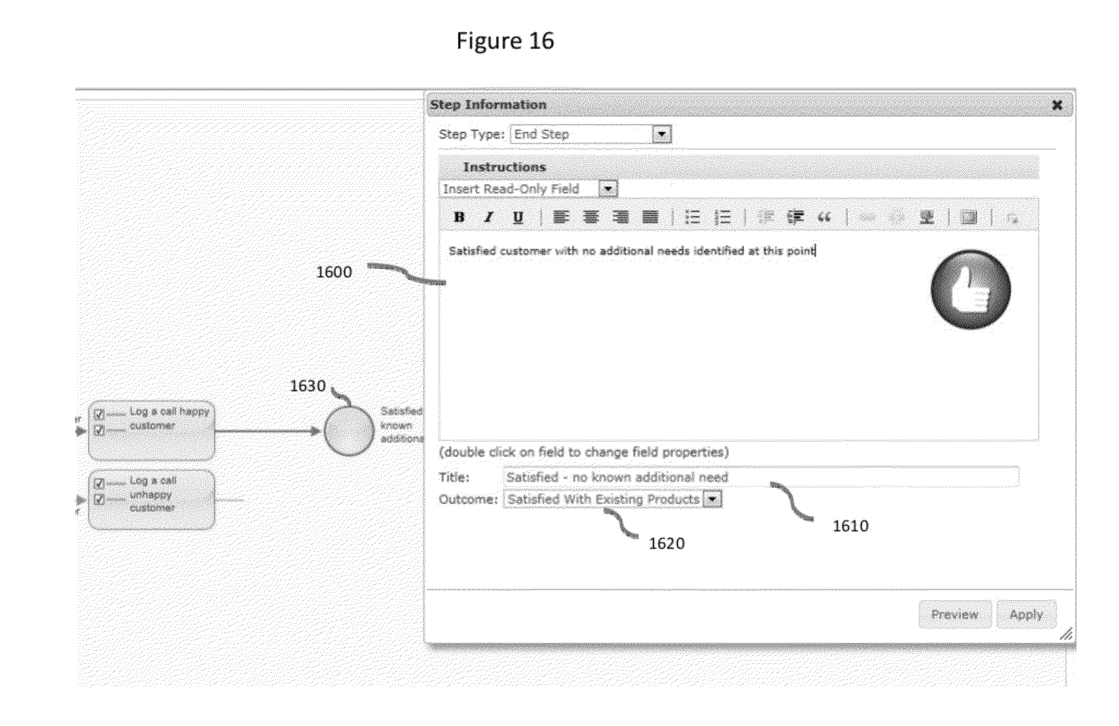

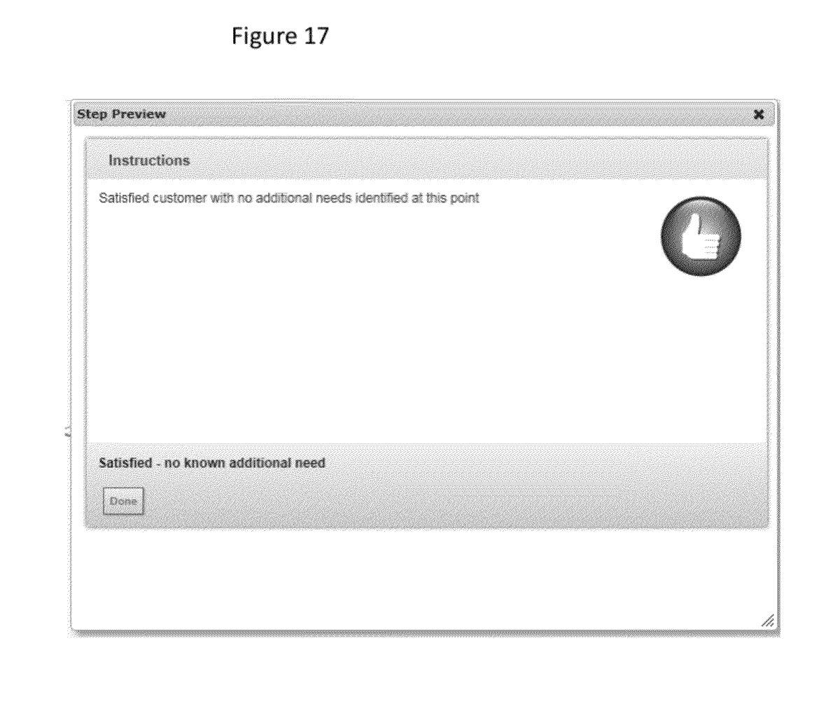

When a guidance tree leads to a final outcome, the developer can optionally create an end step. The end step is the last step in a guidance tree branch. Creation of end steps is useful to developer because the end step icon provides a clear visual ending to a branch. End steps are also useful within the executed screenflow application because the end steps provide instructions and display data for a user of the screenflow. In addition, the end steps provide outcome data that can be used in an embedded guide step. Further, the application development tool can use data obtained from the end step to generate a report about the runtime of the guidance tree, i.e. the time it took an end user to reach the end step outcome. FIG. 16 shows a step information box for an end step. The developer can enter information and/or data within the instruction box 1600, enter a title 1610, and enter an outcome 1620. The end step icon 1630 is a round circle that indicates to the developer that the branch has ended. FIG. 17 depicts the end step of FIG. 16 as it would be displayed to an end user of the screenflow application.

With the application development tool, the developer can also create a step that imports or links to another guidance tree. This step is called an embedded guide step. The advantage of an embedded guide step is that you can design a guidance tree in modules and then connect the guidance trees. The developer can import or link to a guidance tree regardless of whether it is complete, incomplete, published, or unpublished. The potential outcomes of the imported or linked in guidance tree becomes the answers or branches subsequent to the embedded guide step. When running a screenflow application having an embedded guide step, the screenflow application does not have to indicate to the end user that another guidance tree is being accessed. Rather the imported or linked in guidance tree can simply appear like a continuation of steps within the screenflow of the original guidance tree.

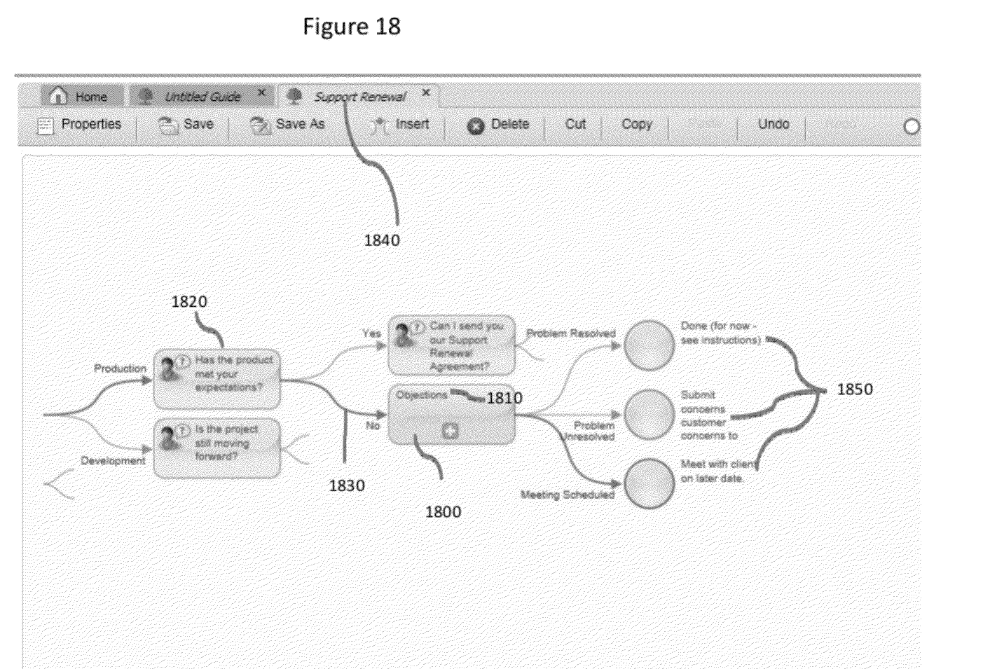

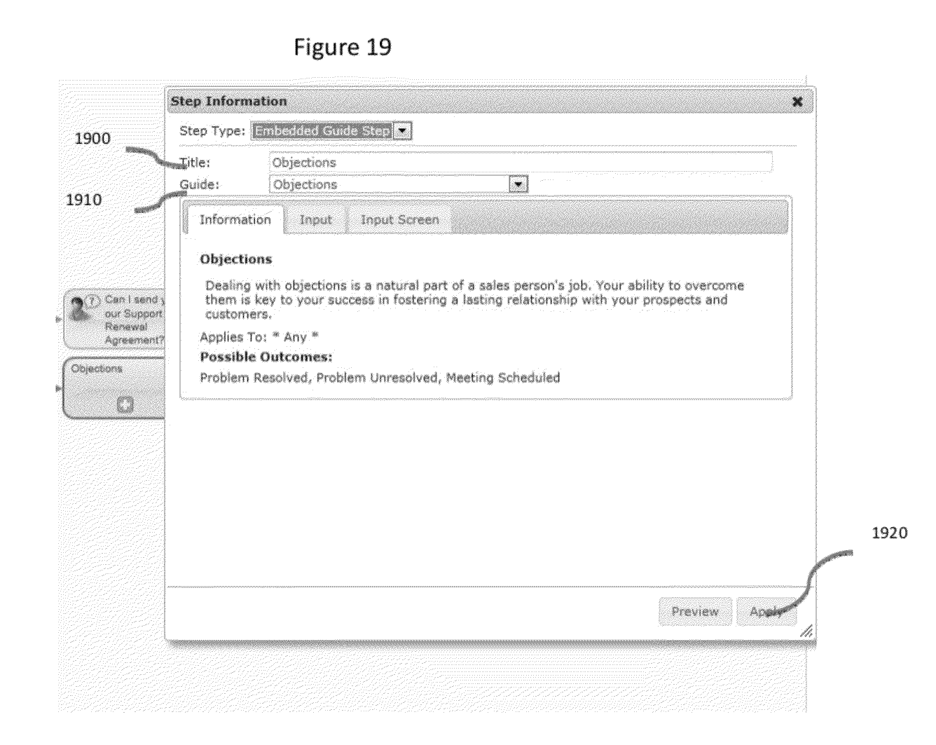

FIG. 18 shows an embedded guide step 1800 within a guidance tree 1840 called Support Renewal. The embedded guide step lists the name of the linked or imported guide 1810, “Objections”. FIG. 19 shows the step instruction box for an embedded guide step 1800. The developer enters a title 1900 for the embedded guide step 1800, selects a guidance tree from the guide drop box 1910, and creates the embedded guide step 1800 upon clicking apply 1920. After the embedded guide step is created, the outcomes of the linked or imported guidance tree show up as answers or steps 1850 following the embedded guide step 1800.

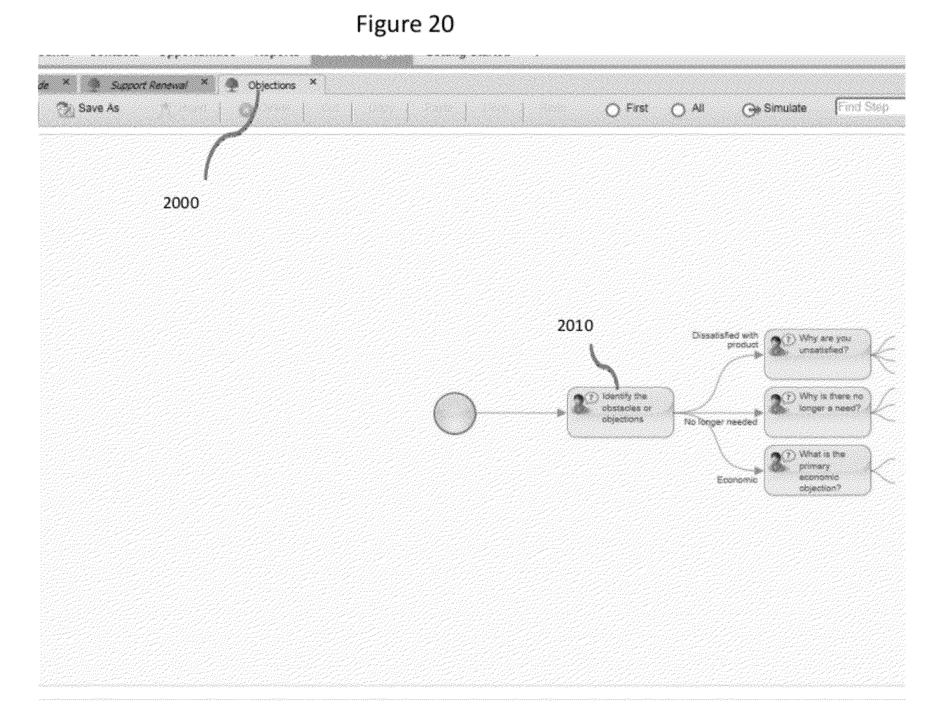

The application development tool allows the developer to enter the linked in or imported guidance tree while designing another tree. For example, the developer can click on the name of the linked or imported guidance tree 1810, and the application development tool will open the linked or imported guidance tree. FIG. 20 shows the results of clicking the name of the linked or imported guidance tree 1810. The linked or imported guidance tree 2000 opens and the developer can begin editing the linked or imported guidance tree 2000. If an end user running a screenflow application of this guidance tree answers No 1830 to step 1820, the end user will automatically be taken to the first step 2010 of the linked or imported guidance tree 2000 via the embedded guide step 1800.

A data decision step allows branching or creation of new steps based on the value of a data field. The application development tool has pre-defined data decision fields with pre-determined answers for use in the data decision step. In addition, the developer can customize answers to pre-defined data decision fields. In certain aspects, a developer can also add customized data decision fields to add as a field option that can be accessed when creating a data decision step. With the customized data fields, the developer can create customized answers that will automatically show up upon selection of the customized data field. Data decision steps are typically short cuts for the developer for commonly used step prompts and answers. Instead of having to manually enter a prompt and answers, pre-defined data decision fields can be selected that automatically display the prompt and answer to create the step. For example, if a food order guidance tree has a drink order step with the answer tea. The next step will logically be a tea step. Instead of creating a prompt and writing down the answers for tea, the developer can use select a pre-defined data decision field for tea that automatically displays the pre-determined answers black, green, or herb

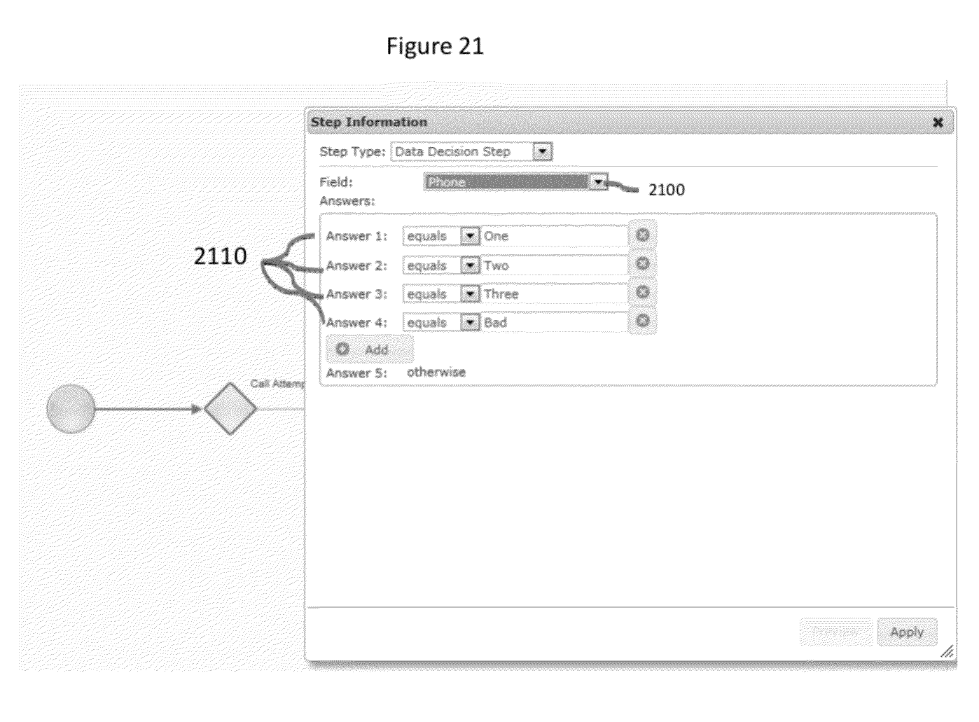

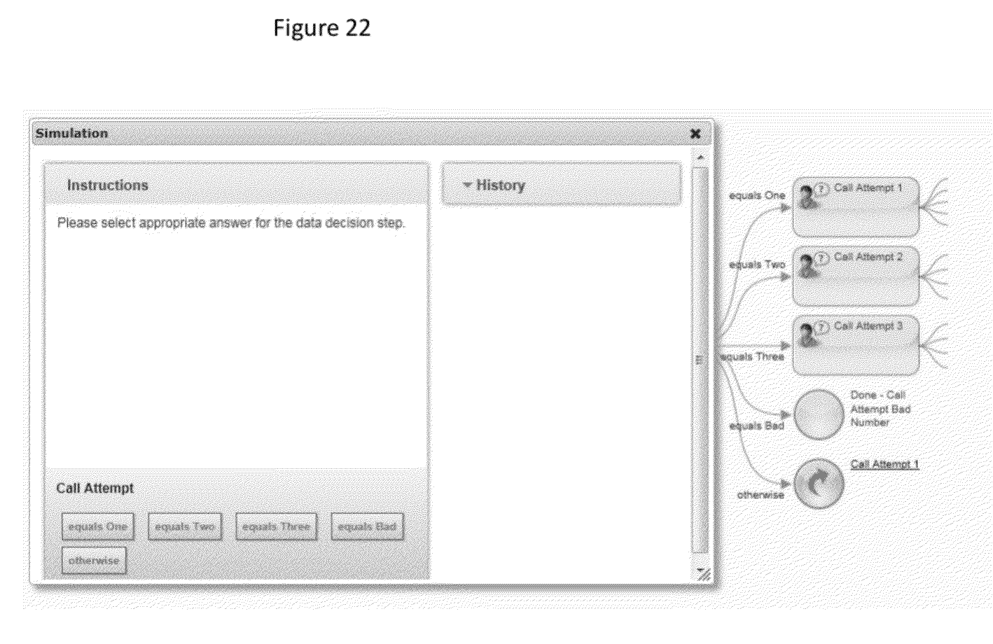

FIG. 21 shows the step information box for a data decision step. The developer enters a pre-defined data decision field or customized data decision field from the field option drop box 2100. After a field is selected, answers 2110, either pre-defined or customized depending on the selected data decision field, automatically show up within the step information box. Optionally, the developer can change the automatically appearing answers or add more answers. FIG. 22 shows the data decision step from FIG. 21 as displayed to an end user using the screenflow development tool.

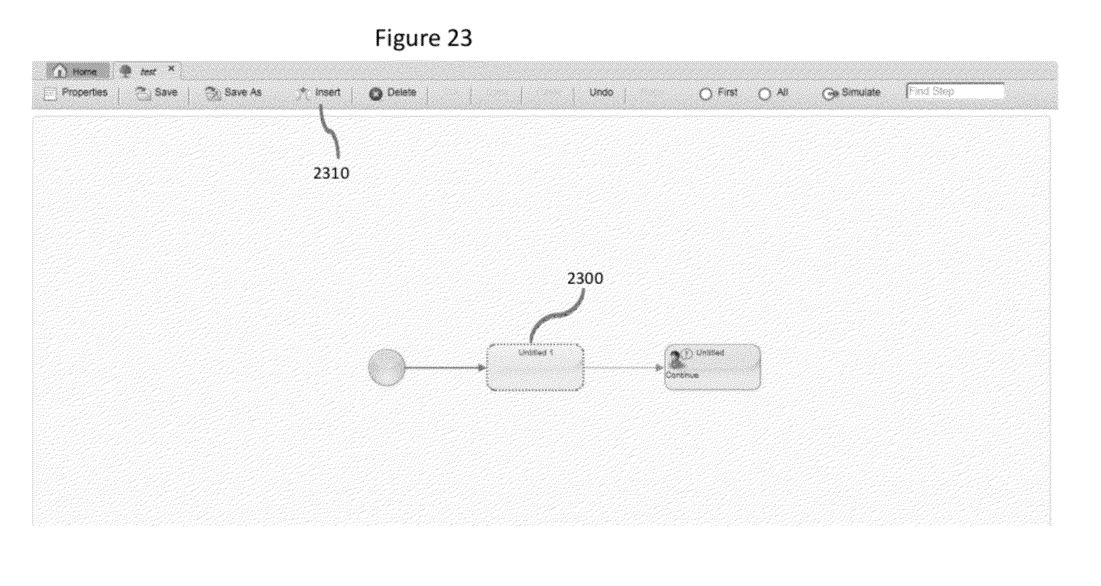

FIG. 23 depicts a placeholder step 2300 within a guidance tree that as indicated by a dashed border and no icons. Placeholder steps 2300 allow a developer to continue working on branches further down the tree without having to complete the step instruction box for one or more previous steps. The placeholder step 2300 can be changed into a screen step, automated step, jump step, end step, or embedded guide step at any time by double clicking the step and selecting a step type within a step instruction box. The placeholder step is created by clicking the insert step icon 2310.

Depending on the complexity of the problem to be solved or the particular task the guidance tree is directing, the developer can create guidance trees that can have a large multitude of branches, steps, and outcomes. The resulting large and complex trees cannot practically fit within the display window of the computing device. Prior art application development tools required constant scrolling and zooming in and out on the guidance tree to find steps to work on or to relate steps. Such scrolling and zooming wastes time and prevents the developer from seeing relationships between the steps he/she is currently working on. In order to solve this problem, the designing environment of the application development tool has several features to reduce clutter and the graphical content within the window of the device while keeping useful and currently utilized information and graphical content within the window.

One feature of the design environment is the guidance tree hierarchy view, which is best explained in terms of familial relationships. With hierarchy view, the graphical content of the guidance tree shown in the window is limited to a selected step that developer is currently working on or has highlighted and the selected step's grandparent and great uncle steps, parent and uncle steps, sibling steps, and descendant steps of the selected step. In addition, branches and any subsequent steps are only shown in only steps that linearly and directly related to the selected step, i.e. the grandparent, parent, and descendants. The branched out descendants of great uncles, uncles, and siblings are not shown. The hierarchy view can be extended to show more ancestors, such as great grandparents, or minimized to only show the parent.

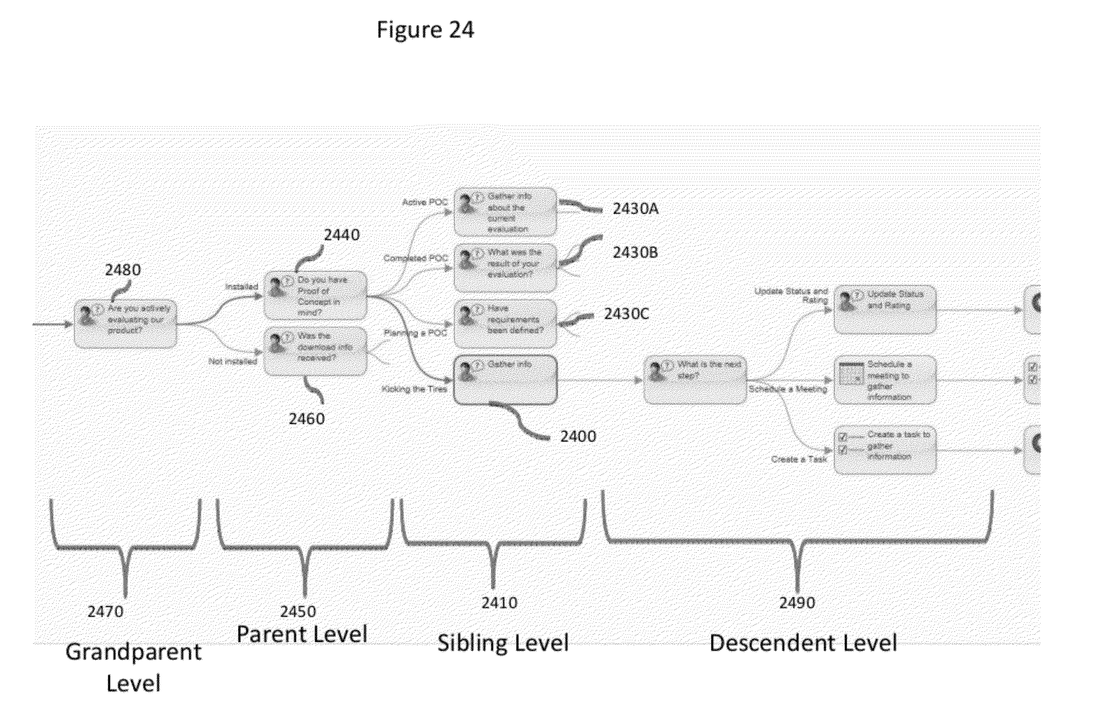

FIG. 24 depicts the guidance tree hierarchy view. The developer has clicked on selected tree step 2400, which is highlighted by bolded lines. The guidance tree hierarchy view shows within the graphical user interface window the siblings 2430A-2430C of the guidance tree step in the sibling level 2410. The siblings 2430A-2430C and the selected tree step 2400 are answers to the parent step 2440. The parent level 2450 shows the parent step 2440 and uncle step 2460 to the selected tree step 2400. The parent level can show any number of uncle steps. The grandparent level 2470 shows the grandparent step 2480, and would show, if any, great uncles to the selected tree step 2400. The descendent level 2490 shows the direct descendants of selected tree step 2400 up to the grandchildren. Notably not shown within the FIG. 23 are the descendants of the great uncle step 2440 and of the siblings 2430A-2430C. This prevents clutter and allows the developer to focus on selected tree step 2400 and its direct familial line.

In addition, the application development tool automatically changes the graphical content of the window of the computing device to prevent overloading the graphical content on the screen that is not currently being utilized and to efficiently display the steps that the developer is currently working on and one or more related steps. When a developer selects a step, the application development tool expands content related to the selected step and collapses content unrelated to the selected step to allow the developer to focus on the step he/she is currently working on.

In response to selecting a step, the application development tool provides for automatically moving one or more of the steps, collapsing one or more branches, and expanding one or more other branches of the tree within the available window space without changing the size of the window. After the automatic expanding, collapsing, and moving, the window only shows the selected step and one or more steps before or after the selected step. For example, the graphically content can automatically adjust to the hierarchy view of the selected step. The graphical content surrounding the selected step does not have to be in hierarchy view, rather the application development tool can be designed to show only one or more related steps to the selected steps. This means that the developer does not have to use scrolling tool bars to see areas of the tree that the developer wants to work on. Moreover, the developer does not have manually collapse and expand the hierarchy view he/she was previously working on. In addition, the developer does not have to increase the size of the window in order to see the selected step and its relatives. In certain aspects, the moving, collapsing and expending the window to show the selected step and also one or more nodes does not change the size of the selected step, i.e. the application development tool does not require use of a zoom feature.

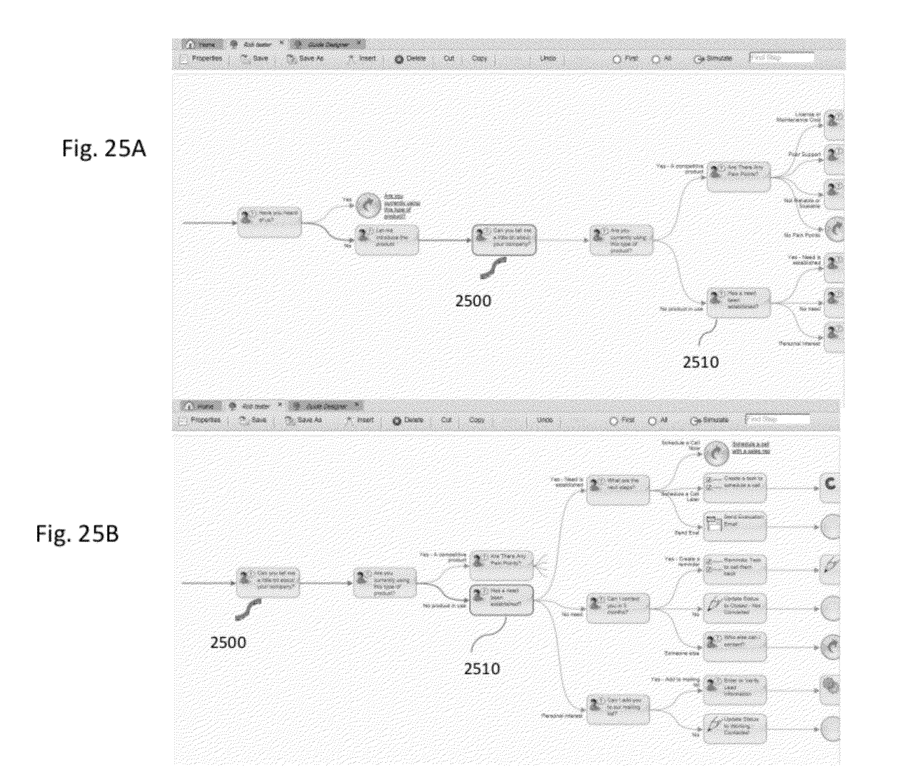

FIGS. 25A and 25B exemplify the automatic expanding, collapsing, and moving of the graphical content of the guidance tree. FIG. 25A shows the hierarchy view for selected step 2500. If the developer wants to work on or see the related steps to step 2510, the developer simply selects step 2510. Upon selecting step 2510, the application development tool automatically moves steps, collapses branches, and expands branches so that the resulting screen display highlights the hierarchy view of step 2510, thus automatically changing the screen display from the hierarchy view of step 2500 to the hierarchy view of 2510. FIGS. 26A and 26B also illustrate the design environment automatically changing due to the developer selecting a step in the guidance tree. FIG. 26A shows related content to selected step 2600. When the developer clicks step 2610 on the graph automatically moves, collapses, and expands the graphical content to show step 2610 and related steps, as depicted in FIG. 26B.

Another feature of the application development tool that aids the developer in creating the guidance tree is the ability to insert, copy, and paste steps and subtrees. A subtree consists of all the connected steps to the right of a selected step. The insert function allows the developer to insert a step to the left of a selected step. The cut function allows the developer to cut or delete a step or subtree. The copy function copies the selected step and all succeeding steps in the path. The paste function allows the developer to input steps or subtrees that have been copied or cut. In addition, the application development tool has delete, undo, and redo functions.

In addition, the developer can stimulate the guidance tree to perform as the screenflow application while designing the guidance tree. Stimulating a guidance tree allows the developer to go through steps of the guidance tree without publishing and running the screenflow application. This allows the developer to see a direct translation from the information the developer placed into the step information box to an actualized screen shot or automated task, thus allowing the developer to see the step as it would appear in the screenflow to an operator.

Referring back to block 30 of FIG. 1, once the developer creates a guidance tree using the application development tool, the developer can publish the developed guidance tree. Publishing is the act of converting a guidance tree into a screenflow application. The screenflow application is an executable guidance tree. Publishing can occur on the developer's computing device or the guidance tree file or template can be sent to the application development and screenflow server for subsequent publishing. In certain aspects, the published screenflow application is placed on the server for use by an end user.

The Publish 350 icon, as shown in FIG. 3, allows the developer to transform a guidance tree into a usable screenflow application. After a guidance tree has been published, the developer can continue to edit the guidance tree. This allows a user to publish a work-in-progress guidance tree as desired, and allows the developer to continually improve on the guidance tree. End users will still have access to the published guidance tree that is being edited in its published form. In certain aspects, the edits made to the guidance tree do not automatically appear within the published guidance tree. Rather, a developer needs to republish the guidance trees for the edits to appear in the screenflow application. The Unpublish 360 icon allows the developer to prevent end user access to the guidance tree screenflow while the developer makes edits.

In order to keep track of one's edits, the application development provides publication status dates for each saved guidance tree. Publication statuses include Published, Not Published, Published-but-out-of-date. Published-but-out-of-date alerts the developer that changes have been made since the last publication, and the current screenflow application does not include these changes. The guidance tree will need to be republished to include the changes in the resulting screenflow application. The status updates are provided in the guidance tree details 390, as shown in FIG. 3.

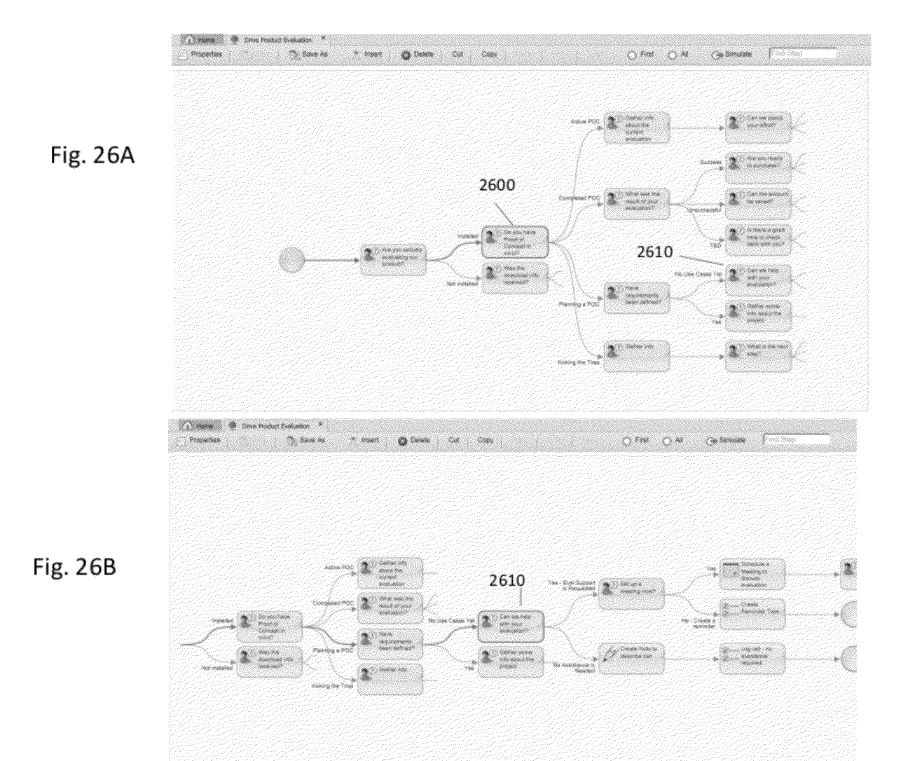

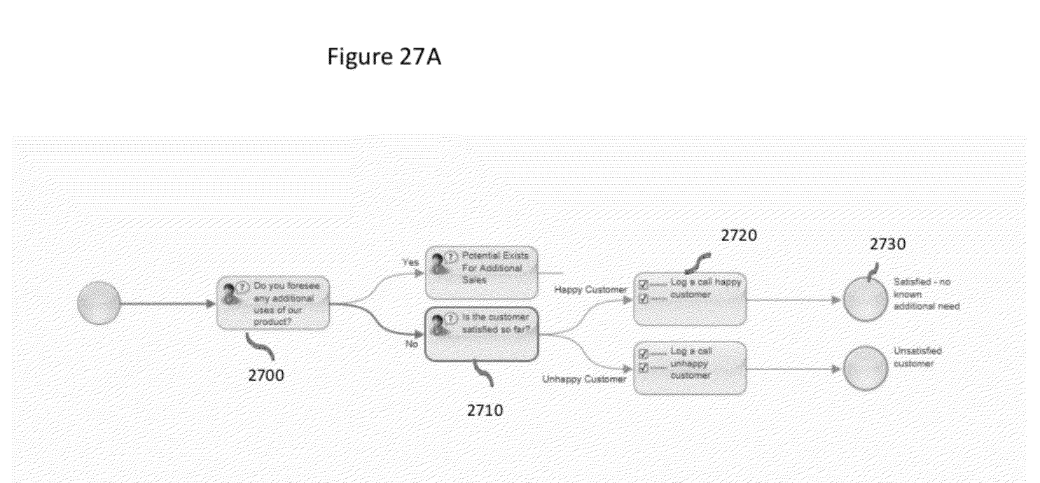

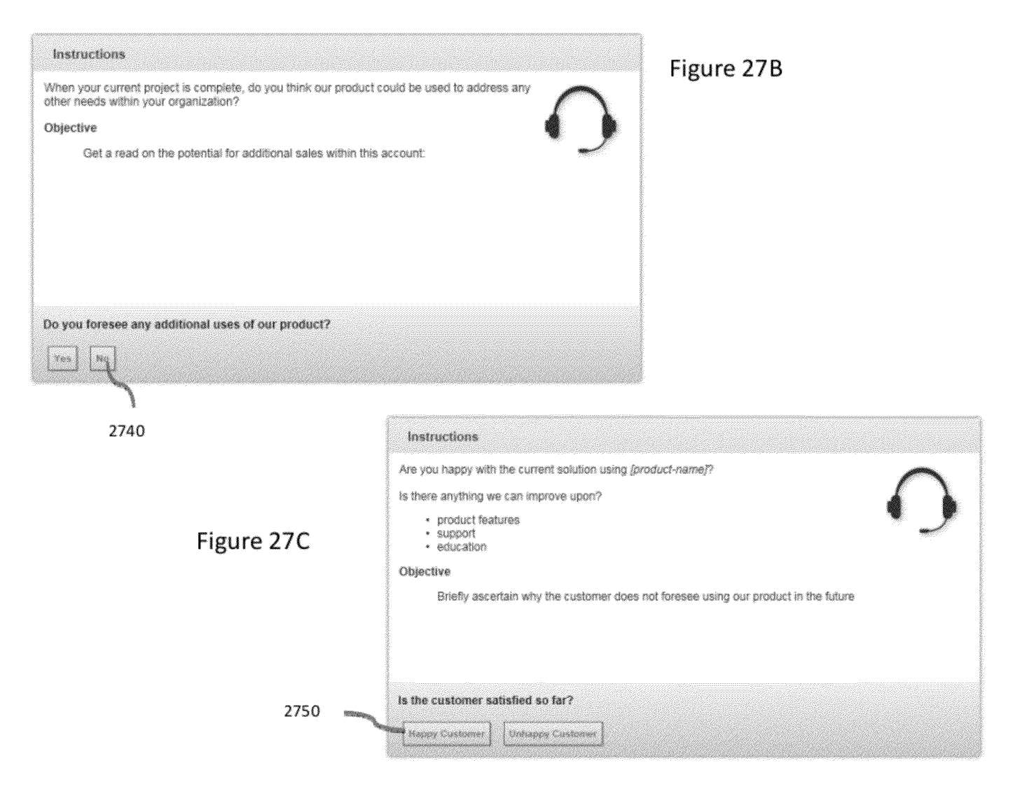

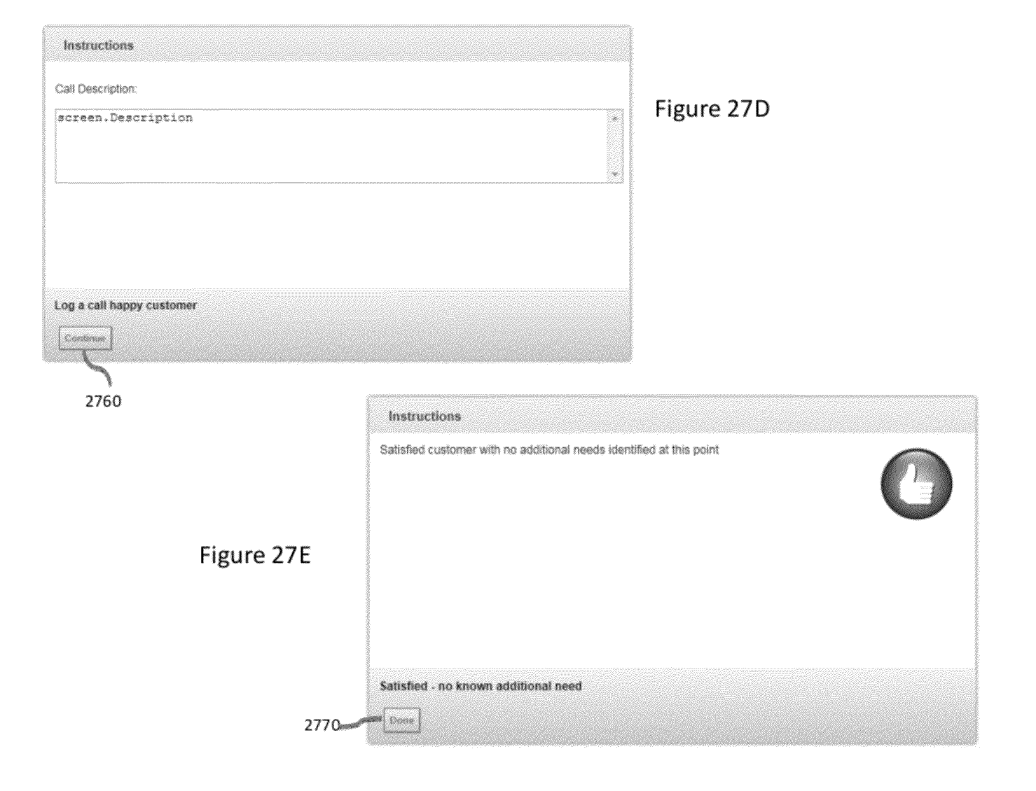

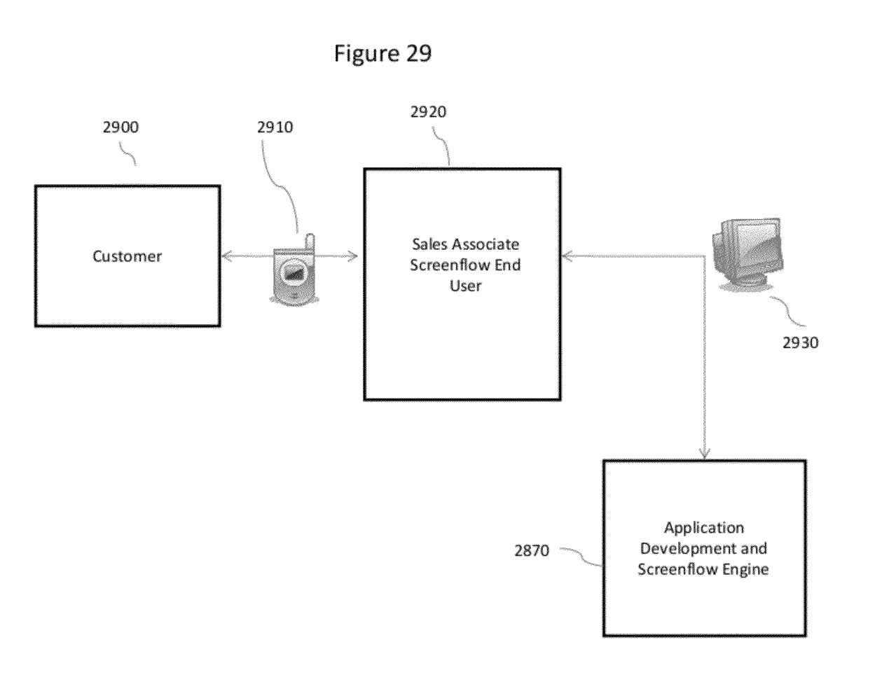

The published screenflow application can be business process. End users can use the resulting screenflow application to solve a problem or be directed through a task. For example, a sales associate can be assigned to cold call a customer to ask if the customer might have future needs for a product. To increase efficiency of the sales associate, the company's head sales associate developed a screenflow application using the application development tool to direct the task flow of the sales associate making the cold call. FIG. 27A depicts a completed guidance tree designed to help a sales associate make a call to a customer in order to see if the customer would be interested in any futures products or services of the company, in other words to assess the customer's future needs. FIG. 29 is a schematic diagram representing a sales associate using a computing device to access the screenflow server and database to run a screenflow for step-by-step guidance during a customer phone call. The sales associate end user 2920 can use the computing device 2930 to connect over a computer network to the application development and screenflow engine 2870 in order to access and run the screenflow application generated by the guidance tree of FIG. 27A. Following the screenflow application, the sales associate end user 2920 can then call 2910 a customer 2900 to assess the customer's future needs. The sales associate screenflow end user's 2920 conversation with the customer 2900 is dictated by the screenflow, and the path of the screenflow depends on the customer's 2900 responses to the end user's 2920 questions.

FIGS. 27B-27E are screenshots of the resultant screenflow application from the completed guidance tree in FIG. 27A, and represent a step-by-step path the end user 2920 can take while running the screenflow. A history section within FIGS. 27B-27E shows the end user 2920 the path taken in the screenflow up to the current step by providing the step description and the answer of each preceding step. FIG. 27B corresponds with tree step 2700. In FIG. 27B, the end user 2920 is prompted to ask the customer 2900, “Do you foresee any additional uses of our product?” If the customer 2900 says “No”, the end user 2920 selects “No” 2740 and the screen depicted in FIG. 27C appears. FIG. 27C corresponds with step 2710. In FIG. 27C, the screenflow screen instructs the end user 2920 to ask if the customer 2900 is happy with the current product and if there is anything else that the company can approve upon. Depending on the customer's 2900 answers, end user 2920 is prompted to assess whether the customer 2900 is satisfied so far. If the end user 2920 assesses that the customer 2900 generally likes the company's product, the end user 2920 clicks “Happy Customer” 2750 and the end user 2900 is brought to the screen as shown in FIG. 27D. FIG. 27D corresponds with step 2720. In FIG. 27D, the screenflow screen asks the end user 2920 to enter a description of the phone call 2910 with the customer 2920 within the provided input box. When the end user 2920 finishes entering the call description and presses “Continue” 2760, the screenflow application automatically logs the happy customer call and leads the end user to the screenflow screen in FIG. 27E. FIG. 27E corresponds with step 2730. In FIG. 27, the end user 2920 has completed the task of finding out if there are future needs, and clicking “Done” 2770 closes the screenflow application.

### Incorporation by Reference

References and citations to other documents, such as patents, patent applications, patent publications, journals, books, papers, web contents, have been made throughout this disclosure. All such documents are hereby incorporated herein by reference in their entirety for all purposes.

### Equivalents

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

1. A method of changing the graphical content in a window while a developer creates an application with a development tool where the application represents a process, the method comprising:
providing the developer with a graphical user interface window on a display device of a computer being used by the developer;
allowing the developer to create the application graphically with the development tool and within the window by defining a plurality of nodes that together form a tree with a plurality of branches, each of the nodes representing either a screen to be displayed to a user when the application is executed or an activity to be performed when the application is executed; and
in response to the developer selecting one of the nodes, automatically moving one or more of the nodes within the window and also collapsing one or more branches of the tree and expanding one or more other branches of the tree within the window to show the selected node and also one or more of the nodes before and after the selected node within the available space of the window and without changing the size of the window.

2. The method of claim 1 wherein the moving step comprises the automatic moving, collapsing, and expanding within the window to show the selected node and also the one or more of the nodes before and after the selected node within the available space of the window and without changing the size of the selected node.

3. The method of claim 1 wherein the application is defined by the plurality of nodes and wherein the application represents a business process.

4. The method of claim 1, wherein the application guides the user to solve a problem or through a particular task.

5. The method of claim 1, wherein the activity to be performed is automatically performed.

6. The method of claim 1, wherein each of the node represents a step towards solving a problem or a step in conducting a particular task when the application is executed.

7. The method of claim 1, wherein a node of the plurality of nodes further represents a data entry user interface on the screen to be displayed to the user when the application is executed.

8. A computer system for allowing a developer to create an application, the computer system comprising:
a display device,
a processor, and
a computer-readable medium containing instructions which when executed by the processor cause the processor to:
provide the developer using the computer system with a graphical user interface window on the display device;
allow the developer to create the application graphically and within the window by defining a plurality of nodes that together form a tree with a plurality of branches, each of the nodes representing either a screen to be displayed to a user when the application is executed or an activity to be performed when the application is executed; and
in response to the developer selecting one of the nodes, automatically move one or more of the nodes within the window and also collapse one or more branches of the tree and expand one or more other branches of the tree within the window to show the selected node and also one or more of the nodes before and after the selected node within the available space of the window and without changing the size of the window.

9. The computer system of claim 8 wherein the computer-readable medium also contains instructions which when executed by the processor cause the processor to automatically move, collapse, and expand within the window to show the selected node and also the one or more of the nodes before and after the selected node within the available space of the window and without changing the size of the selected node.

10. The computer system of claim 8 wherein the application represents a business process.

11. The computer system of claim 8 wherein the computer-readable medium comprises one or more of RAM, ROM, flash memory, magnetic storage, and optical storage.

12. The method of claim 8 wherein the application guides the user to solve a problem or through a particular task.

13. The method of claim 8 wherein the activity to be performed is automatically performed.

14. The method of claim 8 wherein each of the nodes further represents a step towards solving a problem or a step in conducting a particular task when the application is executed.

15. The method of claim 8 wherein a node of the plurality of nodes further represents a data entry user interface on the screen to be displayed to the user when the application is executed.
